(19) United States
(12) Patent Application Publication
(10) Pub. No.: US 2011/0112986 A1
(43) Pub. Date: May 12, 2011

(54) Generative Investment Method and System

(75) Inventors: Steven Dennis Flinn, Houston, TX (US); Naomi Felina Moneypenny, Houston, TX (US)

(73) Assignee: MANYWORLDS, INC., Houston, TX (US)

(21) Appl. No.: 13/007,958

(22) Filed: Jan. 17, 2011

Related U.S. Application Data
(63) Continuation of application No. 11/467,491, filed on Aug. 25, 2006, now abandoned.

(30) Foreign Application Priority Data
Jan. 18, 2005 (US) PCT/US2005/001348

(51) Int. Cl. G06Q 40/00; G06F 15/18

(52) U.S. Cl. 705/36 R; 706/12

(57) ABSTRACT

A generative investment process method and system is disclosed for managing investment opportunities. The process decomposes investment opportunities into capability components and represents the opportunities and capability components as elements of a computer-implemented combinatorial model. The process may identify uncertainties associated with elements of the combinatorial model, generate expected values of information gathering actions, make inferences from the results of the information gathering actions, and update the combinatorial model accordingly. New investments may be generated basis combinatorial operations on elements of the combinatorial model.

### CROSS REFERENCE TO RELATED APPLICATIONS

The present application is a continuation of patent application Ser. No. 11/467,491, which claimed priority to PCT Patent Application No. PCT/US2005/001348, which claimed priority under 35 U.S.C. §119(e) to U.S. Provisional Patent Application Ser. No. 60/558,107, entitled “A Method and System for Generative Investment Processes,” filed on Apr. 1, 2004.

### FIELD OF INVENTION

This invention relates to investment processes and, more particularly, to business methods and software used to develop and manage investment processes.

### BACKGROUND OF THE INVENTION

Investment processes and associated enabling systems are methods in which projects, programs, investment ideas, or, more generally, “opportunities,” progress through a series of evaluations, resulting in decisions to continue, suspend, or discontinue the opportunities. Investment processes of this type include venture investment processes, including commercial venture capital processes, as well as venture processes internal to businesses and institutions, capital allocation projects or program processes, product or service development processes, solution development processes, research and development (R&D) and other types of innovation processes, and business development and growth processes and initiatives. The investment processes may be associated with organizations, or with respect to individual decision makers, in either a business context, or regarding matters of individual or private concerns.

An “opportunity,” as used herein, is defined broadly as a set of potential business activities that involves some level of investment in order to yield a potential return, reward, or most generally, enhanced value, associated with the opportunity. The required investment may include financial or other types of resource commitments, or may include a combination of financial and non-financial commitments.

In prior art practices, typically there exists multiple opportunities that pass through a series of prescribed evaluation steps, or stage gates. The prescribed steps or stages may be formalized, or may be more informal in nature. At each stage gate, a decision is made as to whether to progress the project or opportunity to the next stage. At each stage, additional information becomes available that may be analyzed, along with previous information from previous stages, in deciding if the opportunity will continue to be considered. The decision may not be independent for each opportunity—collective opportunity portfolio considerations, such as the total prospective investment to be made, may also be considered. Such a prior art stage gate process can be described metaphorically as a funnel—a larger number of opportunities enter the process, and then, at each stage gate, the number of opportunities is potentially reduced.

The prior art stage gate investment process exhibits a number of shortcomings. First, the process is primarily eliminative rather than generative. That is, opportunities, and the associated option value of the collection of opportunities, are continuously reduced throughout the process. Such stage gate investment processes thus strive to maximize the probability that opportunities that should not be funded or implemented are eliminated in one of the stage gates.

Second, the prior art stage gate process is typically sequential in nature. The process is thus not sufficiently flexible to effectively apply more sophisticated decision analytic and design of experiment-based decision approaches to the process.

Third, the prior art stage gate process lacks a decision analytic feedback-based approach. For example, concepts and techniques associated with application of value of perfect or imperfect information associated with opportunities, the design of experiments or general information gathering processes, and the inferencing of experimental or information gathering results are not integrated in a feedback-based process.

Fourth, prior art investment processes naturally tend to separate investment processes associated with new opportunities and growth from investment processes associated with maintaining the existing business. This separation can cause misallocation of investment, resources, and management attention.

Hence, there is a need for an improved process, method, and system to enable more effective investment processes and associated decisions.

### SUMMARY OF INVENTION

In accordance with the embodiments described herein, a method and system for development and management of generative investment processes is disclosed. The generative investment process, as the process is known herein, addresses the shortcomings of the prior art by enabling a generative rather than an eliminative approach to investment decision processes. The generative investment process converts investment processes into a discrete combinatorial system or process model, which enables a potentially unbounded generative capability directly within the process. The generative investment process preferably optimizes synergy value among the collection of opportunities, while preserving option value. The generative investment process effectively applies decision analysis and design of experiment-type approaches to determine the potential actions that can be expected to generate the highest net value of information at each step across the collection of opportunities associated with resolving corresponding uncertainties, preferably at a lower cost than with prior art stage gate processes.

The generative investment process is a feedback-based process, which integrates the concepts and techniques associated with application of the valuation of perfect or imperfect information associated with opportunities, the design of experiments or general information gathering processes, and the inferencing of experimental or information gathering. Preferably, the generative investment process enables an efficient and effective approach to gaining additional information and assimilating the information associated with opportunities. The generative investment process may also integrate investment processes associated with new opportunities and growth with investment processes associated with maintaining existing business.

Other features and embodiments will become apparent from the following description, from the drawings, and from the claims.

### BRIEF DESCRIPTION OF THE DRAWINGS

FIG. 1 is a block diagram illustrating a generative investment process, according to some embodiments;

FIG. 2 is a block diagram of an investment stage gate process, according to the prior art;

FIG. 3 is a flow diagram of the generative investment process of FIG. 1, according to some embodiments;

FIGS. 4A and 4B are block diagrams of opportunities and capability components, respectively, each including capability components, according to some embodiments;

FIG. 5 is a block diagram of two opportunities and their respective capability components, according to some embodiments;

FIG. 6 is a diagram of a capability component affinity matrix, according to some embodiments;

FIG. 7 is a block diagram of a content network, according to some embodiments;

FIG. 8 is a block diagram illustrating encapsulation of objects, according to some embodiments;

FIGS. 9A and 9B are block diagrams of topic and content objects, respectively, according to some embodiments;

FIG. 10 is a block diagram of a content network used by the generative investment process of FIG. 1, according to some embodiments;

FIG. 11 is an opportunity and capability combinatorial map used by the generative investment process of FIG. 1, according to some embodiments;

FIG. 12 is a diagram of the combinatorial map of FIG. 11, following a first round of processing, according to some embodiments;

FIG. 13 is a block diagram of a stage gate process of the first round of processing depicted in FIGS. 11 and 12, according to some embodiments;

FIG. 14 is a diagram of an uncertainty resolution value framework, according to some embodiments;

FIG. 15 is a diagram of an uncertainty resolution cost framework, according to some embodiments;

FIG. 16 is a diagram of an action value framework, according to some embodiments;

FIG. 17 is a diagram of the combinatorial map of FIG. 12, following a second round of processing, according to some embodiments;

FIG. 18 is a diagram of the combinatorial map of FIG. 17, following a third round of processing, according to some embodiments;

FIG. 19 is a diagram of a stage gate process of the available opportunities following the third round of processing of FIG. 18, according to some embodiments;

FIG. 20 is a diagram illustrating operation of a fusion innovation operator used by the generative investment process of FIG. 1, according to some embodiments;

FIG. 21 is a diagram illustrating operation of a fission innovation operator used by the generative investment process of FIG. 1, according to some embodiments;

FIG. 22 is a diagram illustrating operation of an abstraction innovation operator used by the generative investment process of FIG. 1, according to some embodiments;

FIG. 23 is a diagram of the derivation of market or customer value drivers and unfulfilled needs by the generative investment process of FIG. 1, according to some embodiments;

FIG. 24 is a diagram of the mapping of unfulfilled needs to opportunities by the generative investment process of FIG. 1, according to some embodiments;

FIG. 25 is a diagram of the combinatorial map of FIG. 18, following a fourth round of processing, according to some embodiments;

FIG. 26 is a diagram of a stage gate process used to depict the fourth round of processing of FIG. 25, according to some embodiments;

FIG. 27 is a diagram of an uncertainty mapping used by the generative investment process of FIG. 1, according to some embodiments;

FIG. 28 is a diagram of a value of information function used by the generative investment process of FIG. 1, according to some embodiments;

FIG. 29 is a diagram of a design of experiment function used by the generative investment process of FIG. 1, according to some embodiments;

FIG. 30 is a diagram of a statistical inferencing function used by the generative investment process of FIG. 1, according to some embodiments;

FIG. 31 is a diagram illustrating additional aspects of statistical inferencing, according to some embodiments;

FIG. 32 is a diagram illustrating the updating uncertainty mappings and values of information, according to some embodiments;

FIG. 33 is a flow diagram of the generative investment process of FIG. 1, according to some embodiments;

FIG. 34 is a flow diagram of the experimental design and inferencing process of the generative investment process of FIG. 1, according to some embodiments; and

FIG. 35 is a diagram of alternative computer-based system configurations with which the generative investment function of FIG. 1 may operate, according some embodiments.

### DETAILED DESCRIPTION

In the following description, numerous details are set forth to provide an understanding of the present invention. However, it will be understood by those skilled in the art that the present invention may be practiced without these details and that numerous variations or modifications from the described embodiments may be possible.

In accordance with the embodiments described herein, a method for generative investment processes and a system enabling the generative investment process are disclosed. In some embodiments, the generative investment process utilizes the methods and systems of the adaptive fuzzy network and process models as defined in U.S. Pat. No. 6,795,826, entitled “Fuzzy Content Network Management and Access,” PCT Patent Application No. PCT/US04/37176, entitled “Adaptive Recombinant Systems,” filed on Nov. 4, 2004, and U.S. Provisional Patent Application No. 60/572,565, entitled “A Method and System for Adaptive Processes,” filed on May 20, 2004, which are all hereby incorporated by reference as if set forth in their entirety.

Projects, programs, or most broadly, “opportunities,” are ideas that can potentially generate value and that involve investments of time, resources, or financial commitments. Opportunities are found in nearly all business organizations, as well as other institutions, such as non-profit organizations and governmental agencies. These opportunities may be within defined processes, such as business development and growth processes, commercial venture capital, corporate venturing processes, business incubation processes, marketing processes, research and development processes, and innovation processes, or the investment processes and associated activities may be more ad hoc in nature.

In the business arena, in cases where such opportunities are primarily focused on growth, the opportunities may sometimes be thought of as “growth options,” as typically there is an option to execute on the opportunity at any given time, or to not execute on the option. The value of a business can be thought of as a function of the expected present value of operating profits without new growth options, plus the expected value of growth options (See the working paper, “Investment, Valuation, and Growth Options”, Abel et al, May 2003, revised March 2004). As used herein, “opportunities” are meant to encompass “growth options,” as well as projects, programs, ideas, and the like, and may include any potential business activity that involves some level of investment in order to yield a potential return.

The existing art with regard to managing investment opportunities focuses on evaluation of the opportunities, both in absolute terms and in relative terms. Also known are innovation methods in developing new opportunities. Typically, the innovation methods are separated from the evaluation processes, except during individual prototyping activities.

By contrast, the generative investment process is an integrated method for continuously generating and evaluating investment opportunities. The method improves on the existing art by systematically generating a greater number of valuable opportunities and doing so more efficiently, in some embodiments. Evaluations of the opportunities are conducted both individually and collectively, and the acquisition of information required for evaluations is conducted efficiently and effectively. Furthermore, the generative investment process integrates investment processes associated with new opportunities with investment processes associated with maintaining existing business.

As noted above, prior art investment processes can be metaphorically thought of as “funnel processes,” where opportunities are progressively winnowed down. The generative investment process, in effect, “flips the funnel”—that is, a larger number of opportunities may exit the investment process than enter the process.

The decompositional and recombinant approach of the generative investment process effectively converts investment processes into discrete combinatorial processes. Discrete combinatorial processes are capable of generating a potentially infinite variety of meaningful combinations of elements from a finite set of elements. For example, two known examples in nature of discrete combinatorial systems are 1) genetic processes and 2) human language (“generative grammar”), both of which exhibit obvious generative capabilities (see “The Language Instinct,” Pinker, 1994, pp. 84-85).

A discrete combinatorial process or system may be defined as a process or system that includes a finite number of elements that may be recombined through application of specific rules or algorithms to generate a potentially unlimited number of recombined elements, with the recombined elements potentially being grouped or structured in a variety of ways. Thus, the properties of the structures of combined elements may be distinct from the properties of the constituent elements themselves.

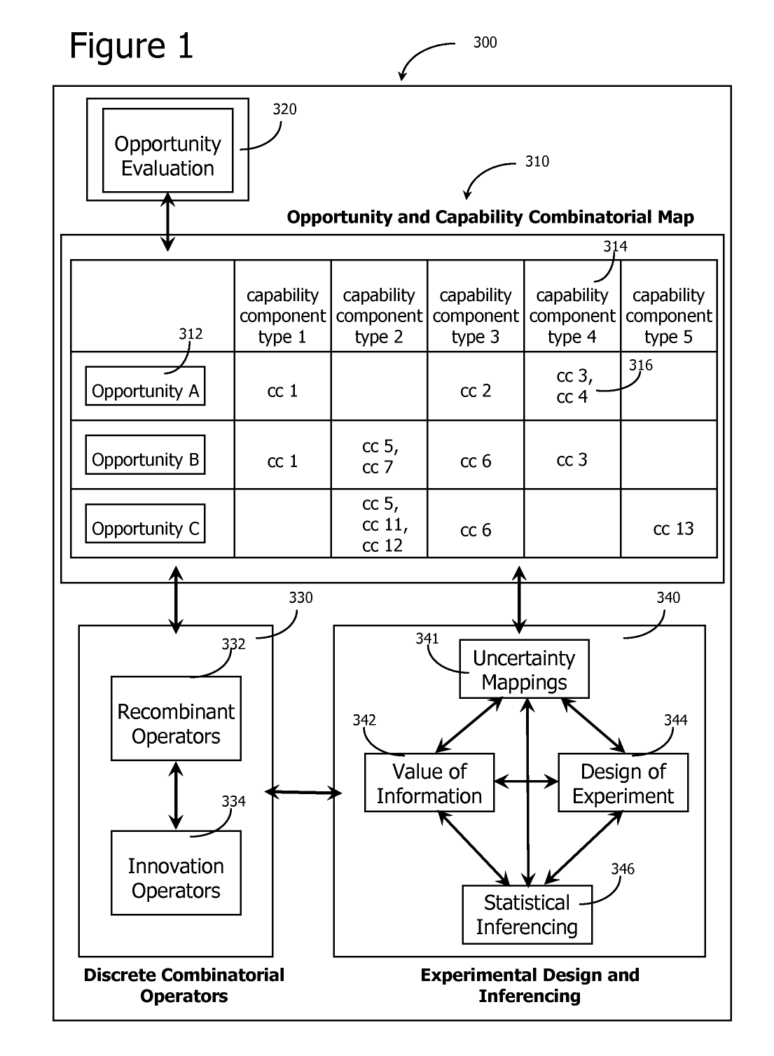

FIG. 1 summarizes an exemplary architecture 300 of one embodiment of the generative investment process. A combinatorial mapping of opportunities and constituent capability components is depicted as a table 310. An opportunity 312 may include one or more capability components 316, corresponding to one or more capability component types 314. In this example, opportunity A includes four capability components 316 (cc 1, cc 2, cc 3, and cc 4), associated with three capability component types 314 (types 1, 3, and 4). Two capability components 316 (cc 3 and cc 4) corresponding to opportunity A are also associated with capability component type 4. The set of all elements associated with the combinatorial mapping 310, that is, the set of all opportunities 312 and capability components 316 associated with the combinatorial mapping 310, may be termed the “discrete combinatorial investment portfolio,” or just “combinatorial investment portfolio”.

The combinatorial map 310 also includes affinities among the elements (opportunities 312 and capability components 316) described above. Affinities, as used herein, are relationships between the elements. As an example, where opportunity A and B are simultaneously owned by the same company, an affinity would be used to describe the ownership relationship. Synergies are types of affinities in which the combination of two or more elements are more valuable than the sum of the independent elements. The set of elements (opportunities and capability components), the relationships, and the associated relationship values within the combinatorial map 310, are collectively termed entities, as used herein.

Discrete combinatorial operations may be applied to the combinatorial mapping 310. The discrete combinatorial operators function 330 may include recombinant operators 332 and innovation operators 334. The recombinant operators 332 generate new combinations of capability components 316 and opportunities 312 from the existing combinatorial mappings 310. The innovation operators 334 apply heuristics or algorithms to inform the recombinant operations 332, and may generate new capability components 316 and opportunities 312 that do not already exist within the combinatorial mapping 310. In some embodiments, the innovation methods include general innovation or creativity approaches, as well as procedures for systematic invention and problem solving, such as are described in the Theory of Inventive Problem Solving, also popularly known by the Russian language-derived acronyms TRIZ and ARIZ (“The Innovation Algorithm,” Altshuller, 1998). The innovation processes and the creation of new opportunities may also be based on the formal or informal gathering of marketplace or customer needs or unfulfilled needs. Together, the combinatorial mapping 310 and the combinatorial operators 330 of FIG. 1 constitute a discrete combinatorial system or process applied to investment processes.

Integrated with this discrete combinatorial investment process (310 and 330) is an evaluation function 320, which applies decision criteria to gauge the value of investment opportunities within the combinatorial mapping 310. The evaluation function 320 may apply decision criteria that may be based on financial criteria (such as net present value, option value, internal rate of return, return on investment, payback period, investment level, and discounted cash flow) associated with opportunities and constituent capability components, and/or may be based on non-financial criteria (such as risk, cultural fit, ability for the organization to execute, and timing). Combining functions 310, 330, and 320 yields an evaluative discrete combinatorial process applied to investment processes. The examples of financial and non-financial criteria given are merely illustrative and not exhaustive. The decision criteria may apply one or more of the financial and non-financial criteria.

Integrated with the evaluative discrete combinatorial investment process (310, 330, and 320) is an experimental design and inferencing process 340. The experimental design and inferencing process 340 addresses uncertainties that may exist with regard to opportunities 312 and capability components 316 in the combinatorial mapping 310. The experimental design and inferencing process 340 may include one or more of: an uncertainty mapping function 341, a value of information function 342, a design of experiment function 344, and a statistical inferencing or learning function 346.

The uncertainty mapping function 341 includes a mapping of uncertainties with corresponding elements of the combinatorial investment map 310. Each element (the opportunities 312 and the capability components 316) of the combinatorial investment map 310 may be associated with one or more uncertain variables, known herein as uncertainties. The uncertainties may be based on subjective assessments, or may be derived from statistical or probabilistic modeling techniques.

The value of information function 342 enables a determination of absolute and relative values of perfect or imperfect information associated with uncertainties of opportunities 312 and capability components 316 within the table 310, as defined by the uncertainty mappings 341. The value of information may be in regard to uncertainties associated with individual elements of 310, or for multiple elements of the table 310. Based on the value of information, a design of experiment or experiments, or broadly, an experimental plan, for achieving additional information may be developed by the design of experiment function 344. It should be understood that the term “experiment,” as used herein, does not necessarily connote scientific information gathering. Rather, “experiment” connotes any action to gather information intended to resolve uncertainties in any domain or field.

In addition to the value of information, the expected cost of conducting experiments or gathering information is incorporated by the design of experiment function 344 in determining an effective information gathering plan. Dependencies among the uncertainties associated with elements or groups of elements of the combinatorial map 310 are incorporated to generate possible suggested sequencing of experiments or information gathering.

The results of experiments, as defined above, may be evaluated or analyzed by the statistical inferencing function 346. The degree of resolution of uncertainties may be directly assigned to the corresponding elements of the uncertainty mapping 341, and may be fed back to the value of information function 342 and the design of experiment function 344. In FIG. 1, the functions 341, 342, 344, and 346 are shown interrelating with one another; these functions are described generally as experimental design and inferencing 340, as performed by the generative investment process 300.

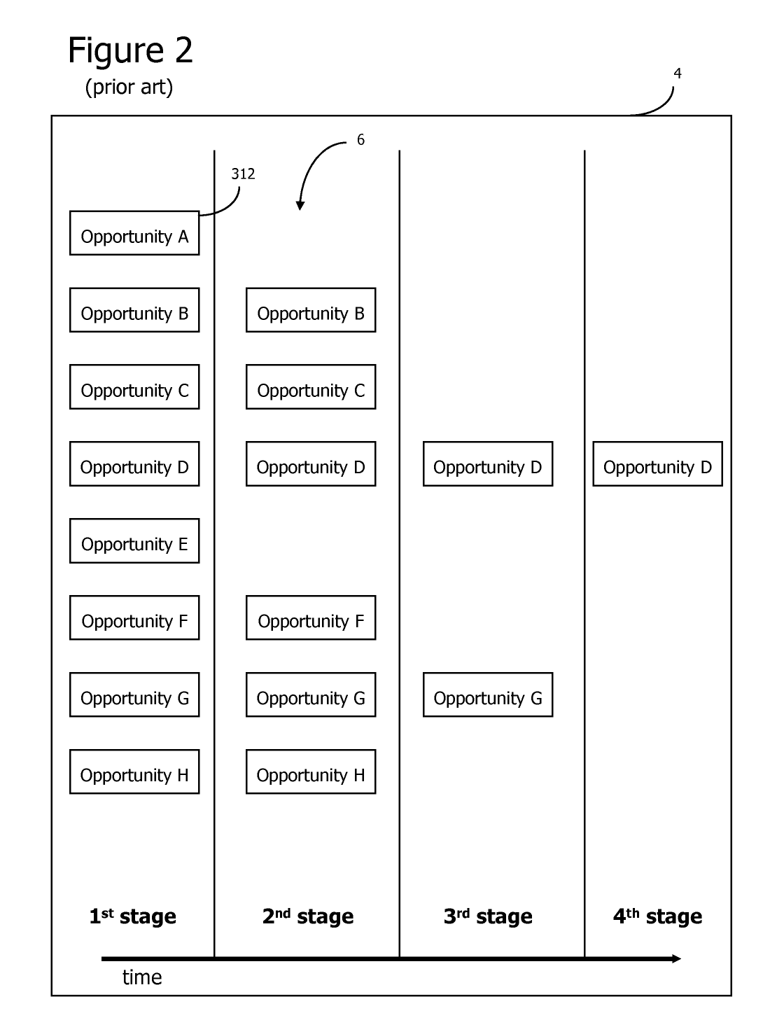

FIG. 2 summarizes a staged process for opportunities, according to the prior art. A process 4 proceeds over time (as indicated by a unidirectional arrow). One or more opportunities 312 progress through one or more process stages or phases 6. Within the stages 6, evaluations of the opportunities may be conducted, and opportunities that do not pass an evaluation are removed or suspended from the process.

As depicted in FIG. 2, a first stage 6 includes opportunities A-H. In a second stage 6, opportunities A and E have been eliminated, leaving opportunities B, C, D, F, G, and H. In a third stage 6, opportunities B, C, F, and H have been eliminated, leaving opportunities D and G. In a fourth stage 6, opportunity G has been eliminated, leaving only opportunity D. Prior art processes are thus generally eliminative in nature (no new opportunities are added), and do not include any feedback mechanism, to allow additional opportunities to be considered following the initial process stage.

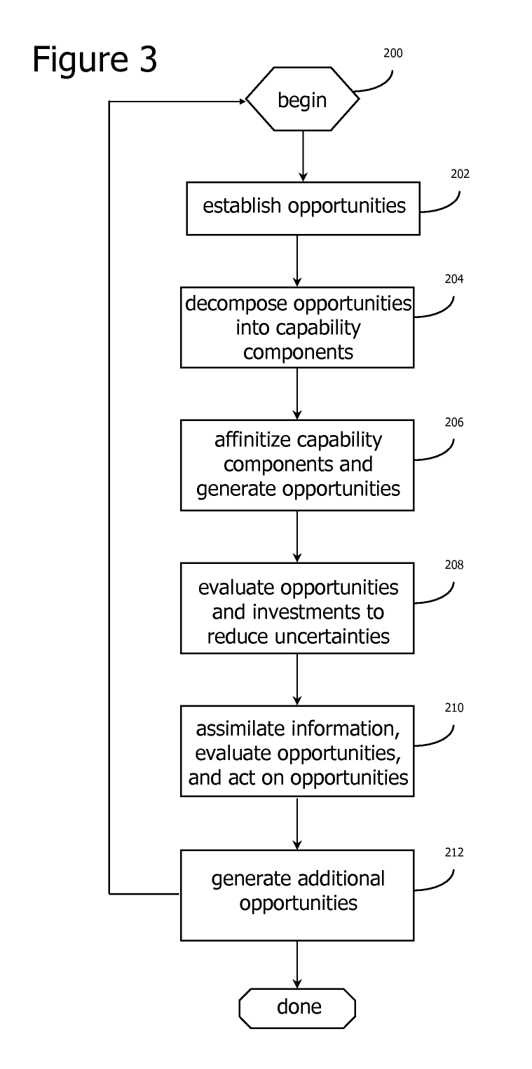

In contrast with the prior art process 4, FIG. 3 is a flow chart of the generative investment process 300 of FIG. 1, according to some embodiments. The generative investment process 300 begins with the establishment of one or more opportunities 312 (block 202). The opportunities are decomposed into capability components 316 (block 204). (Capability components 316 are described in more detail, below.) The capability components 316 are then affinitized in accordance with the type of capability component 314, the degree of relationship between each pair of capability components 316, and the nature of the relationship between each pair of capability components 316. The combinatorial map 310 of FIG. 1 includes these elements and categorizations of elements 312, 314, and 316.

Based on the affinities of elements of the combinatorial map 310 and recombinations of the elements, additional opportunities are generated (block 206). The discrete combinatorial operators 330 of FIG. 1 may be used to generate the new opportunities 312. The values of the opportunities 312 are determined, and investments in reducing uncertainty associated with specific capability components 316 or opportunities 312 are evaluated (block 208). The opportunity evaluation function 320 and experimental design and inferencing function 340 of FIG. 1 may perform such analysis, as described in more detail, below. Information is gathered and the results of the information gathering are assessed and assimilated. The opportunities are then evaluated and acted upon (block 210). Acting on the opportunities 312 may include progressing the opportunities to the next step, or suspending them from the process. Additional opportunities 312 are generated, either through innovation operations on the existing set of opportunities and constituent capability components 316, or through external sources such as customer and marketplace needs and wants (block 212). Opportunities may exit from the process into another process, such as commercialization (not shown), or the opportunities may be part of the next cycle of the process 300 (see feedback arrow).

Although the process 300 is depicted as occurring in a particular order, the steps may occur in an order other than the one shown in FIG. 3, depending on the nature and characteristics of the investment opportunities available. Further, some of the steps are optional for some investment processes.

Typically, opportunities 312 consist of a bundle of two or more capability components 316. For example, even if a business idea (opportunity) is based on a technological break-through, the overall business venture idea is likely to also include other differentiating components, such as processes (e.g., marketing processes). It is the uniqueness of the bundle of components that typically provides the economic value-creating potential of the idea, and provides the ability to defy the easy copying of the opportunity by competitors, which could otherwise lead to rapid value capture declines.

Capability components 316 may include both tangible and intangible aspects of an investment opportunity 312. The capability components 316 may constitute a mutually exclusive, collectively exhaustive set for each opportunity 312. (The term collectively exhaustive, as used herein, means that the elements of a set comprise the totality of the set.) Or, the capability components 316 may represent but a part of the opportunity 312 defined and may simultaneously represent multiple opportunities 312. A myriad of possibilities exist for representing opportunities 312 using capability components 316.

The capability components 316 of opportunities 312 may include products (including prototypes), technologies, services, skills, relationships, brands, mindshare, methods, processes, financial capital and assets, intellectual capital, intellectual property, physical assets, compositions of matter, life forms, physical locations, and individual or collections of people, regardless of resource ownership. Some of these types of capability components 316 may be obvious within a given investing context, but some may be overlooked. For example, in science and engineering-driven companies, “softer” components, such as relationships as distinct capabilities, are often overlooked or under-emphasized. Also, the capability components 316 that may be considered include not only those that are currently “owned” by the business, but also those that may be developed by the company in the future, as well as those that are owned by third parties.

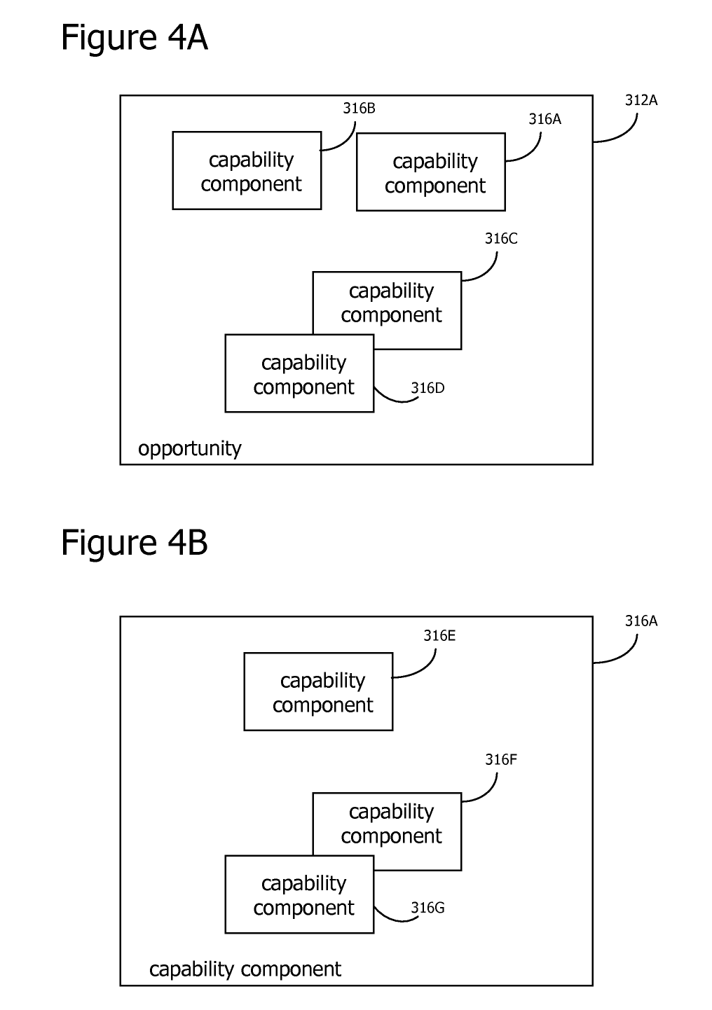

FIG. 4A illustrates the relationship of an opportunity 312A and associated capability components 316A-D, where the capability components 316A-D are not collectively exhaustive. Opportunity 312A includes four capability components 316A, 316B, 316C, and 316D. Capability component 316A is defined to be exclusive of the other capability components 316B, 316C, and 316D. By contrast, capability component 316C is not totally exclusive of capability component 316D, and vice-versa. In other embodiments, the capability components associated within an opportunity may be collectively exhaustive.

In FIG. 4B, capability component 316A from FIG. 4A is illustrated, to show that capability components may be defined in terms of other capability components. Capability component 316A includes three other capability components 316E, 316F, and 316G. The capability component 316E is exclusive of the other capability components 316F and 316G. The capability component 316F is not exclusive of the capability component 316G, and vice-versa. As with opportunities 312, the capability components 316 that include one or more capability components may be collectively exhaustive or not collectively exhaustive. The recursive decomposition of capability components 316 may theoretically continue indefinitely.

The relationships among opportunities 312 and capability components 316 are not necessarily hierarchical, as depicted in FIGS. 4A and 4B. Rather, the relationships may be cyclical, and the relationships may be by degree. Such network topologies of opportunities 312 and capability components 316 may also be recursively decomposed. In such topologies, each decomposition of an investment element (an opportunity or capability component) yields a sub-network.

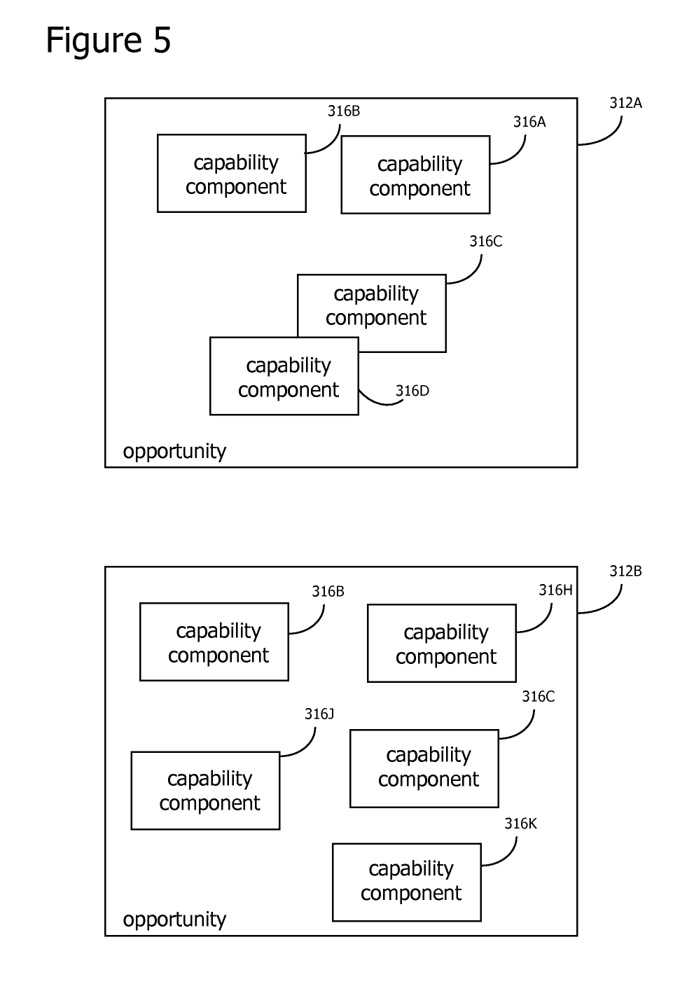

FIG. 5 depicts a pair of opportunities, opportunity 312A (from FIG. 4A) and opportunity 312B. Capability components 316 may be common to more than one opportunity. Thus, both opportunity 312A and opportunity 312B include components capability 316B and 316C. Capability components 316 may also be unique to an opportunity. Thus, capability components 316A and 316D are found in opportunity 312A, but not in opportunity 312B; likewise, capability components 316H, 316J, and 316K are found in opportunity 312B, but not in opportunity 312A.

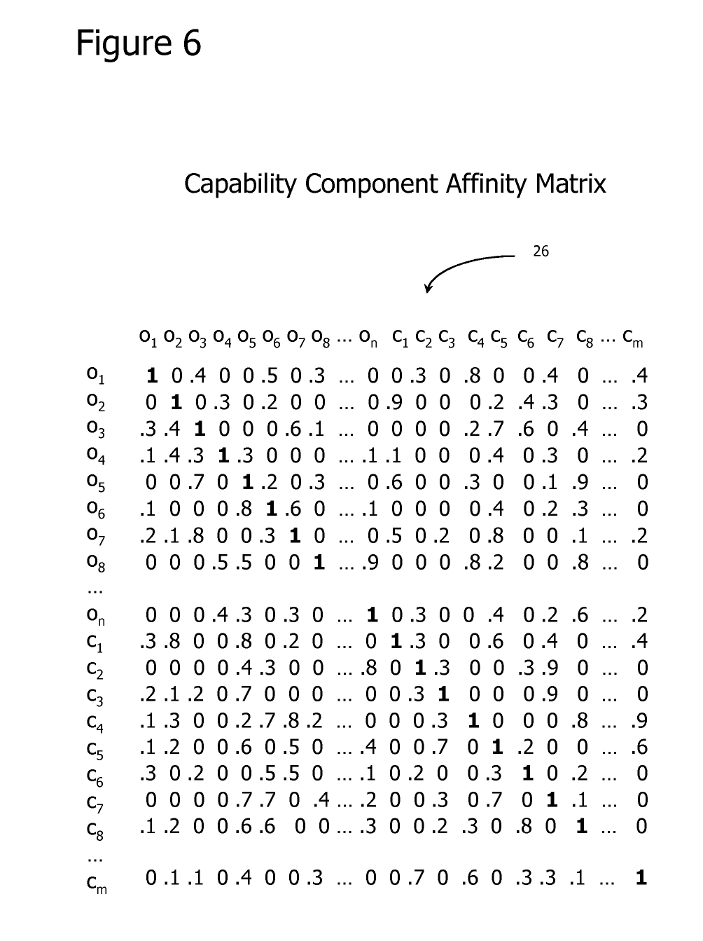

Recall that the generative investment process 300 affinitizes capability components 316 and generates opportunities 312 (FIG. 3, block 206). The affinities between capability components 316 and opportunities 312, and between any two opportunities 312, may be arranged in a capability component affinity matrix 26, as depicted in FIG. 6. For a given investment process, the opportunities 312 and the capability components 316 are arranged in like order along the rows and the columns of the matrix. The entries or values within the capability component affinity matrix 26 symbolically represent weightings or relationships between the associated opportunities 312 or capability components 316.

The diagonal entries of the capability component affinity matrix 26 are set to one, implying the identity relationship, i.e., opportunity 312A is completely related to itself; likewise, capability component 316C has an identity relationship to itself. Other cells of the matrix contain a normalized relationship value, ranging from 0 to 1, inclusive. The weightings may be mapped from other numeric or non-numeric values and may be normalized or not normalized. For example, the weightings may be mapped from “High,” “Medium,” and “Low” relationship values. The values on each side of the identity diagonal may be identical, implying symmetrical relationships among the opportunities 312 and capability components 316. Or, the relationships may be asymmetrical, with potentially different values on each side of the identity diagonal.

The opportunities 312 and the capability components 316 may be represented as a content network, with opportunities 312 being represented by topic objects and capability components 316 being represented by content objects. An embodiment of such a content network is described as follows.

### Content Network

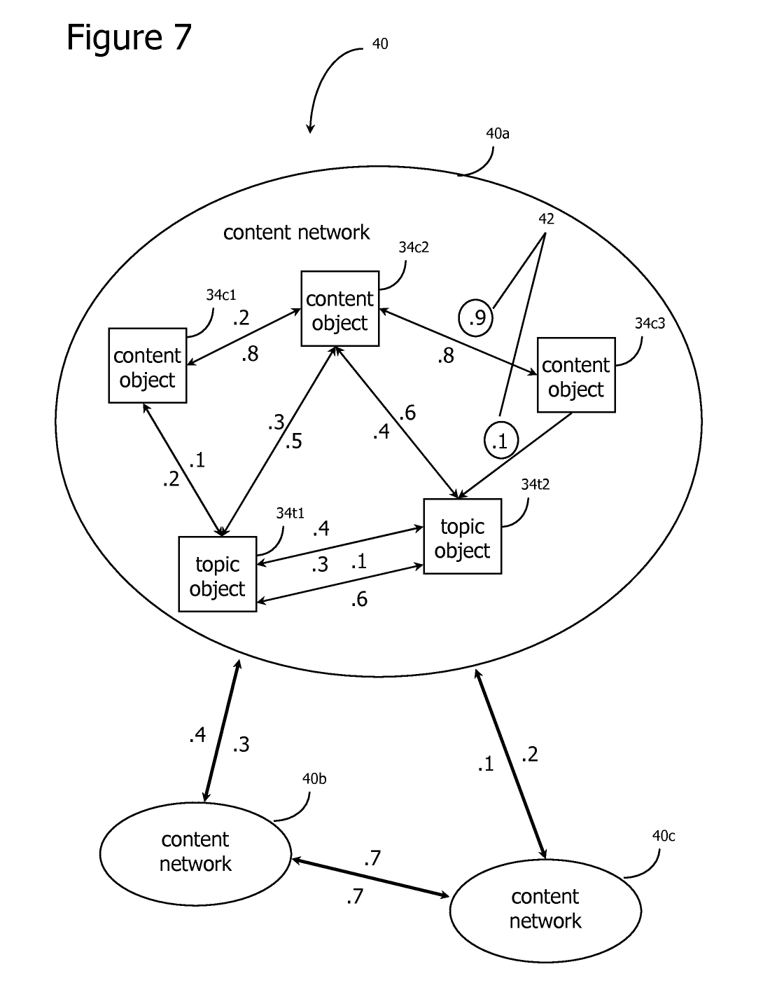

FIG. 7 illustrates a content network 40, including content sub-networks 40a, 40b, and 40c. The content network 40 includes “content,” “data,” or “information,” packaged in modules known as objects 34.

In one embodiment, the content network 40 employs features commonly associated with “object-oriented” software to manage the objects 34. That is, the content network 40 discretizes information as “objects.” In contrast to typical procedural computer programming structures, objects are defined at a higher level of abstraction. This level of abstraction allows for powerful, yet simple, software architectures.

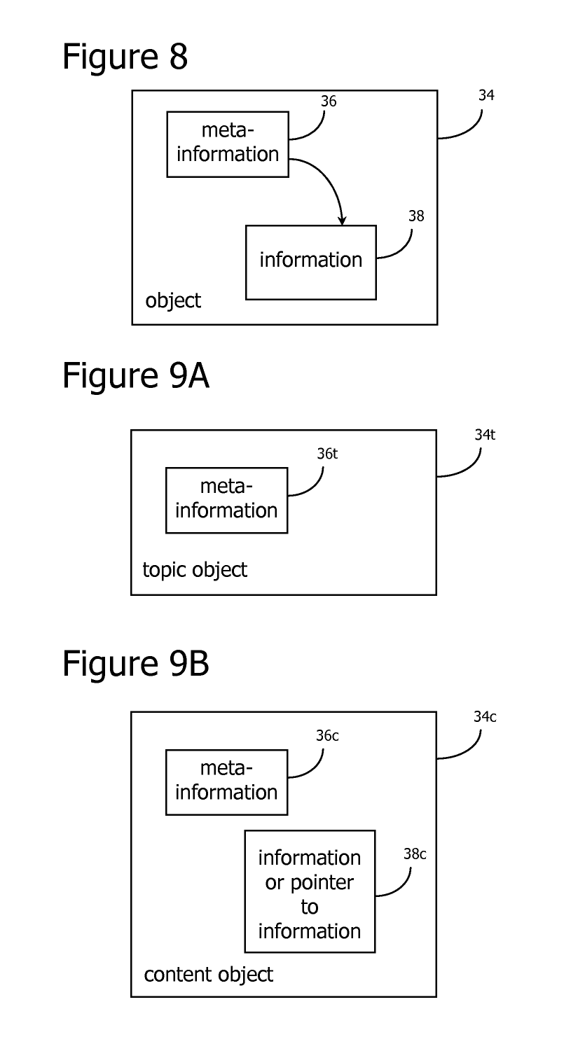

One benefit to organizing information as objects is known as encapsulation. An object is encapsulated when only essential elements of interaction with other objects are revealed. Details about how the object works internally are hidden. In FIG. 8, for example, an object 34 includes meta-information 36 and information 38. The object 34 thus encapsulates information 38.

Another benefit to organizing information as objects is known as inheritance. The encapsulations of FIG. 8, for example, may form discrete object classes, with particular characteristics ascribed to each object class. A newly defined object class may inherit some of the characteristics of a parent class. Both encapsulation and inheritance enable a rich set of relationships between objects that may be effectively managed as the number of individual objects and associated object classes grows.

In FIG. 7, the objects 34 comprise either topic objects 34t or content objects 34c, as depicted in FIGS. 9A and 9B, respectively. Topic objects 34t are encapsulations that contain meta-information 36t and relationships to other objects (not shown), but do not contain an embedded pointer to reference associated information. A topic object 34 essentially operates as a “label” to a class of information. A topic object 34 therefore just refers to “itself” and the network of relationships it has with other objects 34.

Content objects 34c are encapsulations that contain meta-information 36c and relationships to other objects 34 (not shown). Additionally, content objects 34c may include either an embedded pointer to information or the information 38c itself (hereinafter, “information”).

The referenced information 38c may include files, text, documents, articles, images, audio, video, multi-media, software applications, processes (including steps and stages therein) and electronic or magnetic media or signals. Where the content object 34c supplies a pointer to information, the pointer may be a memory address. Where the content network 40 encapsulates information on the Internet, the pointer may be a Uniform Resource Locator (URL).

The meta-information 36 supplies a summary or abstract of the object 34. So, for example, the meta-information 36t for the topic object 34t may include a high-level description of the topic being managed. Examples of meta-information 36t include a title, a sub-title, one or more descriptions of the topic provided at different levels of detail, the publisher of the topic meta-information, the date the topic object 34t was created, and subjective attributes such as the quality of the referenced information. Meta-information may also include a pointer, such as a uniform resource locator (URL), in one embodiment.

The meta-information 36c for the content object 34c may include relevant keywords associated with the information 38, a summary of the information 38, and so on. The meta-information 36 may supply a “first look” at the objects 34. The meta-information 36c may include a title, a sub-title, a description of the information 38, the author of the information 38, the publisher of the information 38, the publisher of the meta-information 38, and the date the content object 34c was created, as examples. As with the topic object 34t, meta-information for the content object 34c may also include a pointer, in one embodiment.

In FIG. 7, the content sub-network 40a is expanded, such that both content objects 34c and topic objects 34t are visible. In one embodiment, the various objects 34 of the content network 40 are interrelated by degrees, using relationship indicators 42. Each object 34 may be related to any other object 34, and may be related by a relationship indicator 42, as shown. Thus, while information 38 is encapsulated in the objects 34, the information 38 is also interrelated to other information 38 by a degree manifested by the relationship indicators 42.

In some embodiments, the relationship indicator 42 is a numerical indicator of the relationship between objects 34. Thus, for example, the relationship indicator 42 may be normalized to between 0 and 1, inclusive, where 0 indicates no relationship, and 1 indicates a subset relationship. In another embodiment, the relationship indicators 42 are expressed using subjective descriptors that depict the “quality” of the relationship. For example, subjective descriptors “high,” “medium,” and “low” may indicate a relationship between two objects 34.

Additionally, the relationship indicator 42 may be bi-directional, as indicated by the double-pointing arrows. Further, each double-pointing arrow includes two relationship indicators 42, one for each “direction” of the relationships between objects 34.

As FIG. 7 indicates, the relationships between any two objects 34 need not be symmetrical. That is, topic object 34t1 has a relationship of “0.3” with content object 34c2, while content object 34c2 has a relationship of “0.5” with topic object 34t1.

Content networks 40 may themselves be related by applying relationships and relationship indicators 42. For example, in FIG. 7, content sub-network 40a is related to content sub-network 40b and content sub-network 40c, using relationship indicators 42. Likewise, content sub-network 40b is related to content sub-network 40a and content sub-network 40c by applying relationships and relationship indicators 42.

Also, individual content and topic objects 34 within a selected content sub-network 40a may be related to individual content and topic objects 34 in another content sub-network 40b. Or, multiple sets of relationships and relationship indicators 42 may be defined between two objects 34.

For example, a first set of relationships and relationship indicators 42 may be used for a first purpose or be available to a first set of users while a second set of relationships and relationship indicators 42 may be used for a second purpose or available to a second set of users. For example, in FIG. 7, topic object 34t1 is bi-directionally related to topic object 34t2, not once, but twice, as indicated by the two double arrows. The content network 40 may thus be customized for various purposes and accessible to different user groups in distinct ways simultaneously.

The relationships among objects 34 in the content network 40 as well as the relationships between content networks 40 may be modeled after fuzzy set theory. Each object 34, for example, may be considered a fuzzy set with respect to all other objects 34, which are also considered fuzzy sets. The relationships among objects 34 are the degrees to which each object 34 belongs to the fuzzy set represented by any other object 34. Although not essential, every object 34 in the content network 40 may conceivably have a relationship with every other object 34.

The topic objects 34t may encompass, and be labels for, very broad fuzzy sets of the content network 40. The topic objects 34t thus may be labels for the fuzzy set, and the fuzzy set may include relationships to other topic objects 34t as well as related content objects 34c. Content objects 34c, in contrast, typically refer to a narrower domain of information in the content network 40.

### Combinatorial Map Represented as a Content Network

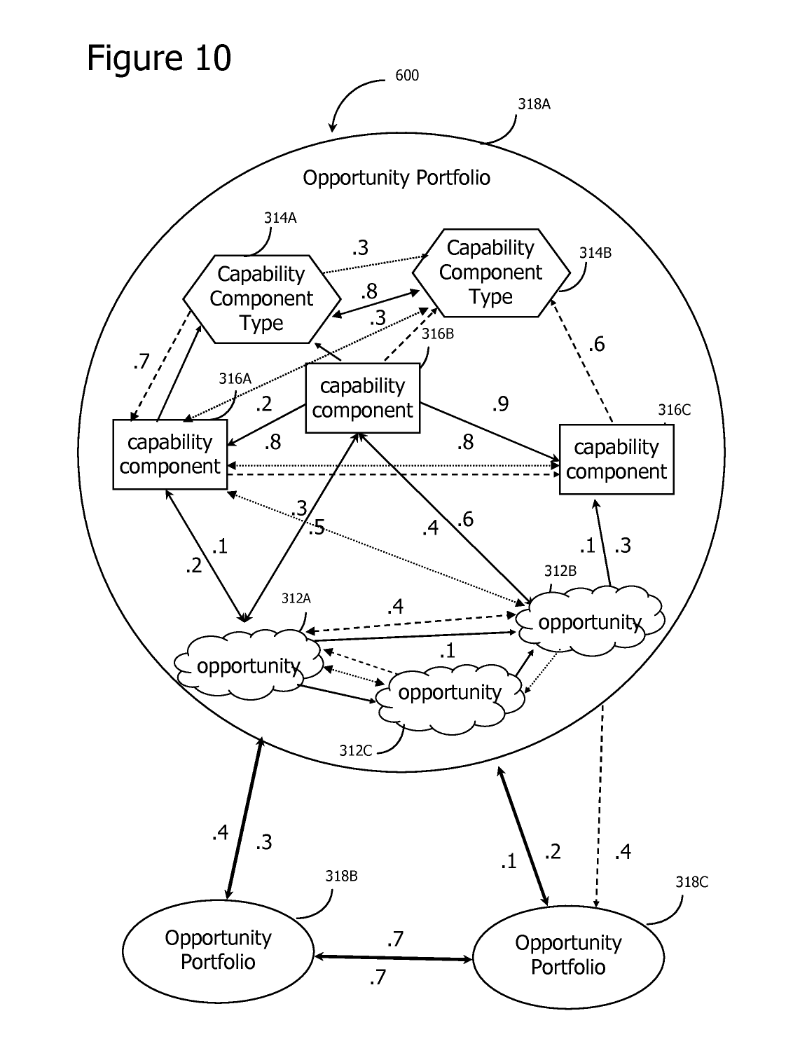

The opportunity and capability combinatorial map 310 may be represented as a fuzzy network, and more specifically as a fuzzy content network. For example as depicted in FIG. 10, capability components (such as 314A and 314B) are represented as content objects, and projects or opportunities 312B and 312C are represented as topic or content objects. Relationship types, relationships and corresponding relationship indicators represent the degree of affinity between any two of the set of capability components and opportunities. The content network 600 further includes capability component types 314A and 314B (see also map 310 of FIG. 1).

In the content network 600, relationships and associated relationship indicators represent the affinities associated with the elements of the combinatorial map 310 of FIG. 1. Uncertainties associated with capability components and opportunities may be represented by either a content object that has relationships to other objects in the network, or by specific types of relationships and associated indicators between objects in the network.

The fuzzy content network representation can be extended to other aspects of the generative investment process 300. For example, uncertain variables, probabilistic models, data sets, values of information and actions may also be represented as objects in the network, and their relationships represented by appropriate relationship types, relationships and relationship indicators. In addition, opportunity portfolios 318B and 318C can be represented as content networks which have relationship types, relationships and associated indicators to other opportunity portfolios.

### Capability Component Combinatorics

According to some embodiments, once the opportunities 312 are decomposed into capability components 316 (block 204 of FIG. 3), the capability components 316 may be rearranged to identify leverage points and synergies. Advantageously, the generative investment process 300 provides insights as to how one or more capability components can enable multiple business ideas. The process 300 further increases the understanding as to which sets of business ideas have synergy through common capability components 316. A medium to large company may have hundreds of business ideas or opportunities 312. The generative investment process 300 thus improves information management, in some embodiments.

The generative investment process 300 may be used to represent the portfolio of projects of the business. Accordingly, the generative investment process 300 may yield significant benefits when the business conducts a structural transaction, such as a merger, acquisition, or joint venture, with other businesses. In the case of a business combination, the generative investment process 300 may yield significant time savings and also increase the potential for innovation as multiple instances of the invention are applied to one or more of the businesses to be combined. Further, the generative investment process 300 can be applied to provide guidance on the value of prospective business combinations or relationships through modeling of a combinatorial map 310 comprised of entities associated with the prospective parties of the business combination or relationship, and thereby serve as input to decisions associated with executing such business combinations or relationships.

Even within a business or enterprise, there may be multiple defined business units or organizations under management. Using the generative investment process 300 in each organization may enable more effective understanding of which capability components 316 are unique to a business unit, as well as identifying opportunities 312 across the portfolio of businesses. In the content network 600 of FIG. 10, three opportunity portfolios 318A, 318B, and 318C (collectively, opportunity portfolios 318) are depicted. The opportunity portfolios 318 may be defined for a single business organization or for multiple business organizations. The organizations may include units of the same company or may include other business organizations such as suppliers or customers. Opportunity portfolio 318A is expanded to show its elements: opportunities (312A, 312B, and 312C), capability component types (314A and 314B), and capability components (316A, 316B, and 316C).

In the content network 600, there are multiple types of relationships between elements that may exist in different ways. For example, there are possibly multiple types of relationships between capability components 316, between capability components 316 and opportunities 312, between capability components 316 and capability component types 314, and between opportunity portfolios 318. Similarly, possibly multiple types of relationships may exist between the various elements in the content network. As shown in FIG. 10, for any two elements within the content network 600, there may be one or more distinct relationships between the elements (as given by a connecting arrow between elements, whether unidirectional or bidirectional), there may be one or more types of relationships (distinguished by different types of lines, whether dotted or thickened), and, associated with each relationship, one or more relationship indicators, which indicate the value and affinity of the relationship. The directional arrows indicate the direction of the relationship between elements.

The types of relationships between elements describe the context between the elements in the content network 600, whether opportunities 312, capability components 316, capability component types 314, or opportunity portfolios 318. The types of relationships are used to evaluate the opportunity portfolio 318 as a whole, in addition to aiding the understanding of the impact of a particular capability component 316 or opportunity 312. Examples of types of relationship include, but are not limited to: advantaged/disadvantaged, leverage, ownership, privileged knowledge, strategic alignment, and sequential relationships or staging. In FIG. 10, the various types of relationships are visually represented using distinct arrows, such as dotted, dashed, and thickened arrows.

### Opportunity Decomposition and Affinitizing

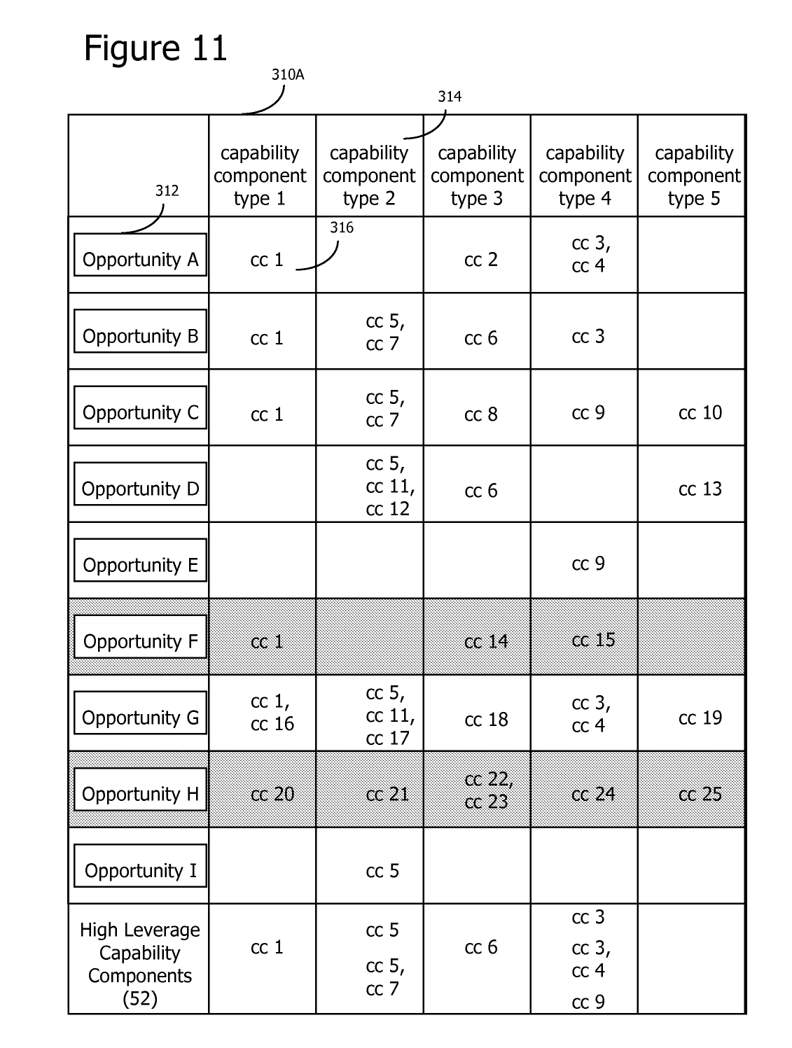

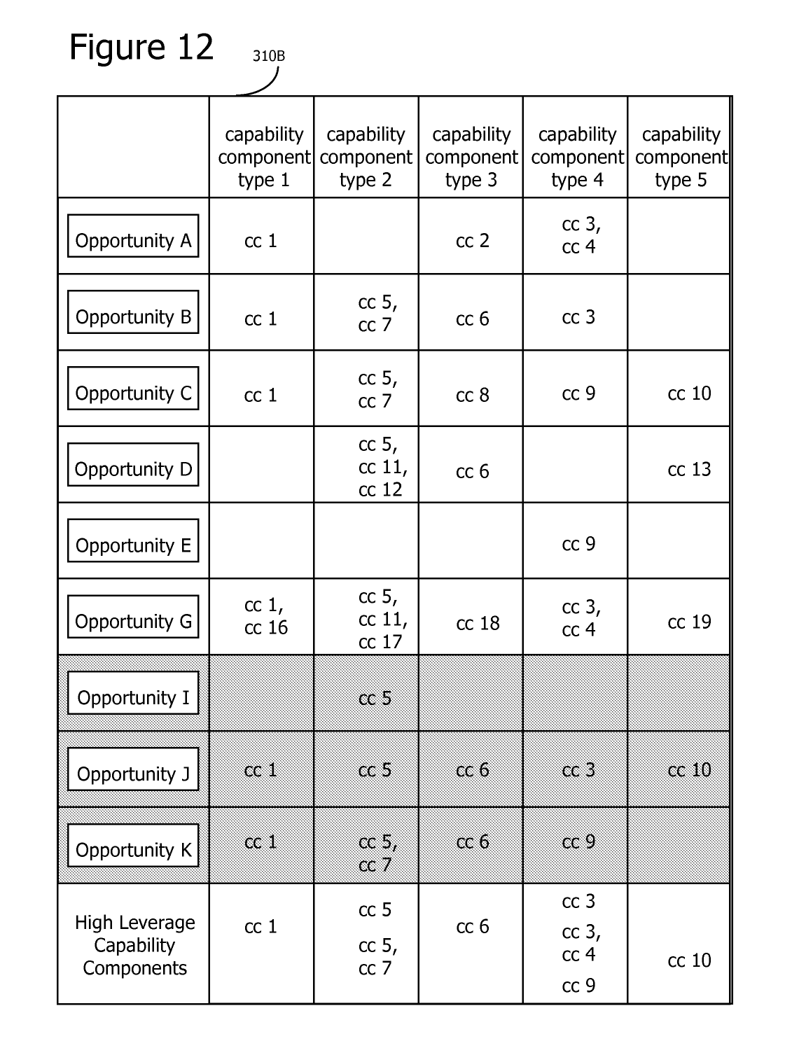

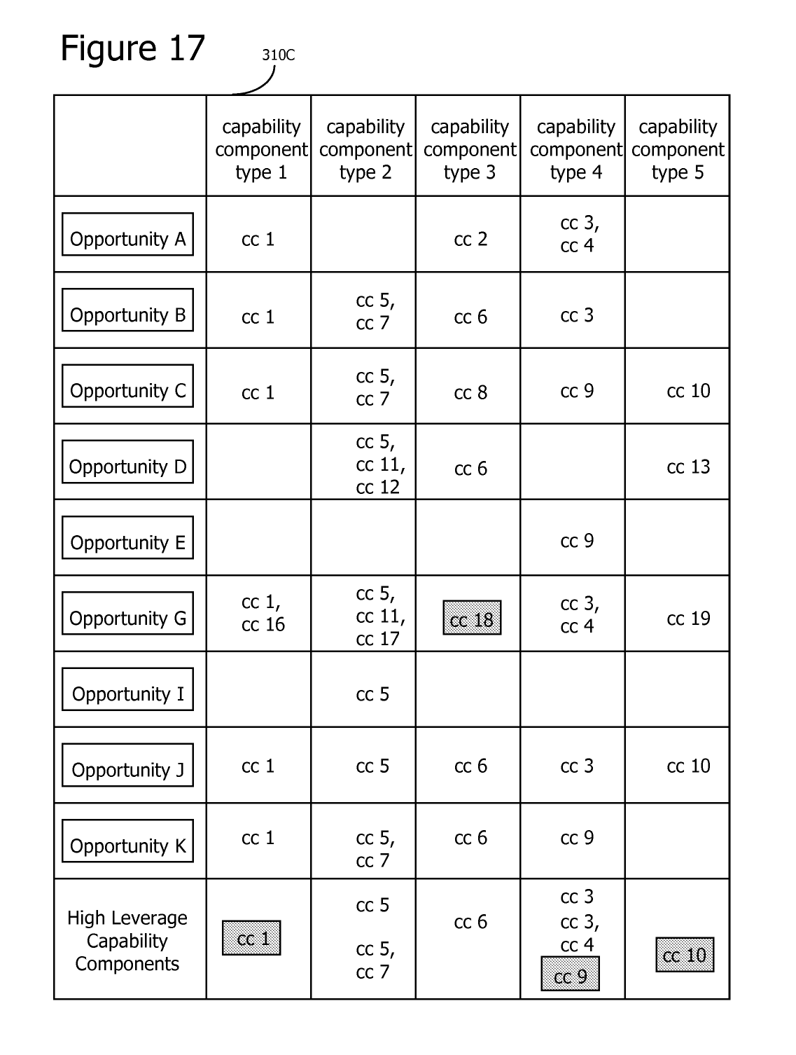

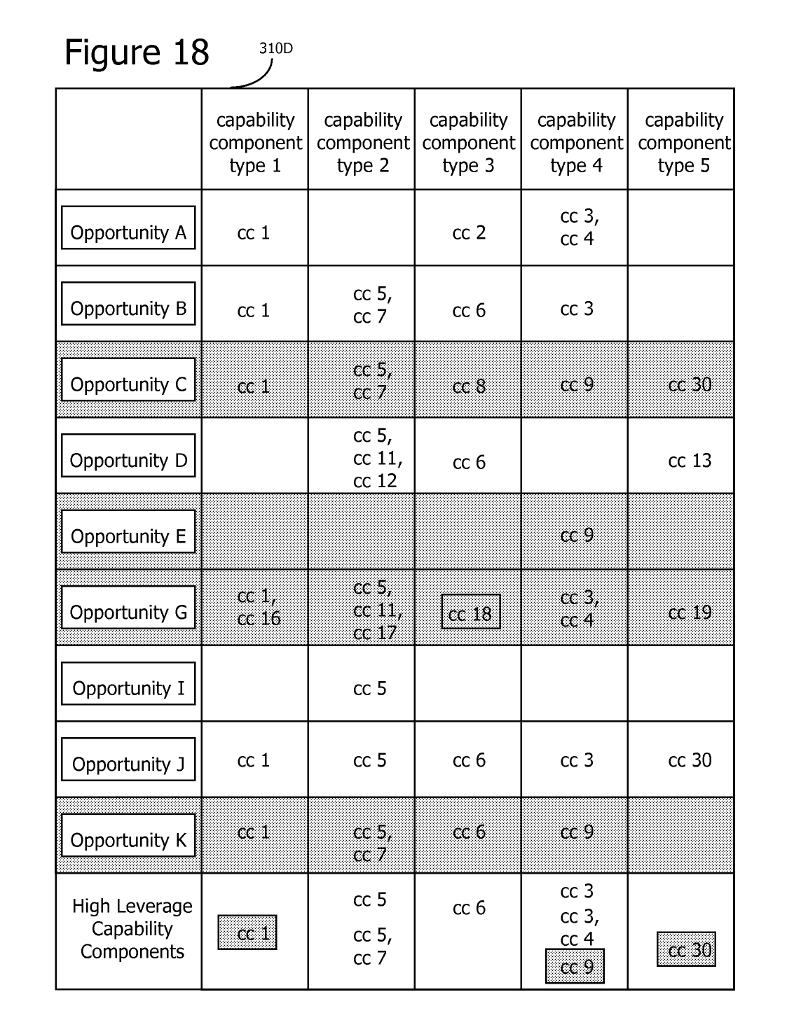

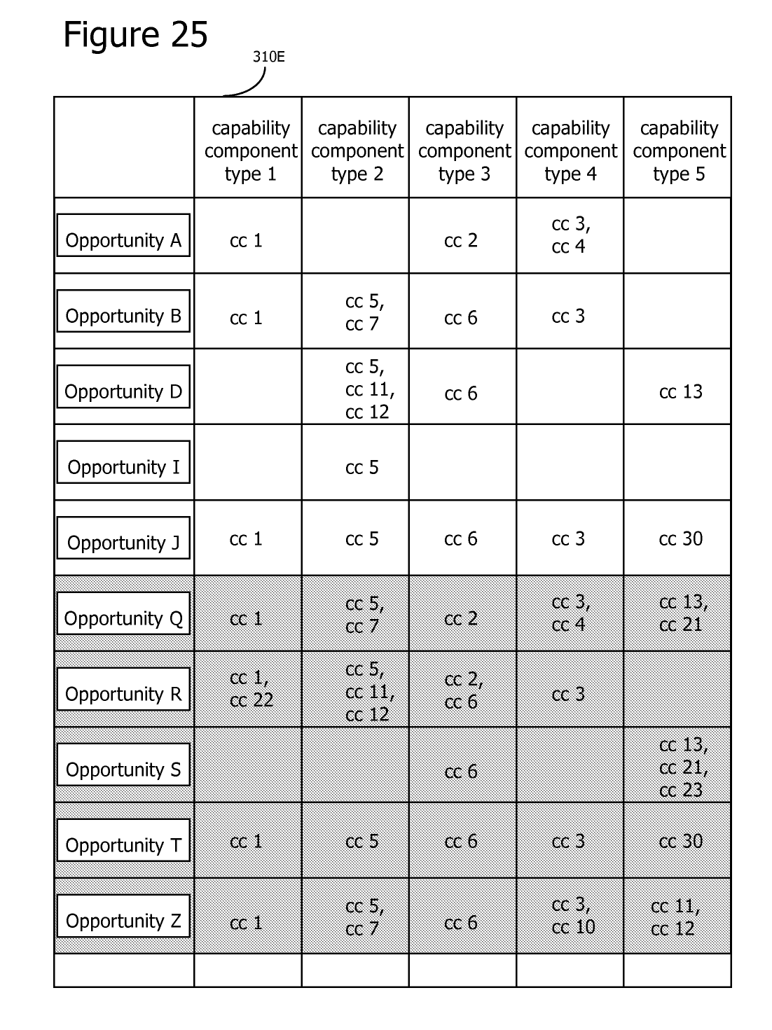

FIG. 11 depicts a particular embodiment of the opportunity and capability component combinatorial map 310 of FIG. 1. The map 310A, as well as maps 310B (FIG. 12), 310C (FIG. 17), 310D (FIGS. 18), and 310E (FIG. 25) present examples to illustrate how the generative investment process 300 of FIG. 1 performs the decomposition and affinitization of opportunities 312, according to some embodiments. The capability components 316 of each opportunity 312 are grouped, categorized, or affinitized by type 314, which preferably range from one to an unlimited number of types. In the example of FIG. 11, five types 314 of capability components are listed as column headings in the table 310A. The types 314 may include, but are not limited to, products, technology, services, skills, relationships, brands, mindshare, methods, processes, financial capital and assets, intellectual capital, intellectual property, physical assets, physical locations, and individual or collections of people.

Each table entry, an intersection between an opportunity 312 and a capability component type 314, may contain one or more capability components 316. Thus, associated with opportunity D, three capability components (cc 5, cc 11, and cc 12) are of capability component type 2, while a single capability component (cc 6) is of capability component type 3 and a single capability component (cc 13) is of capability component type 5. The data included in the combinatorial map 310A may also be represented in a content network diagram, such as the diagram 600 of FIG. 10.

For example, in FIG. 10, recall that the opportunity portfolio 318A includes capability component types 314A and 314B, as well as capability components 316A, 316B, and 316C and opportunities 312A, 312B, and 312C. Each capability component type 314 represents a category comprising different types of relationships and associated relationships and relationship indicators. Relationships (arrows) and associated relationship indicators (numerals) are drawn between capability component types (314A and 314B), between capability component types and capability components (e.g., between 314A and 316A), and between capability components and opportunities (e.g., between 316B and 312A).

The table 310A of FIG. 11 may optionally include an additional row entry, high leverage capability components 52. Thus, the affinitization of capability components 316 (step 206 of FIG. 3) may include identifying capability components 316 that are contained in multiple opportunities 312. These are identified as “high leverage” capability components 52 if they pass a specified threshold of occurrences within a plurality of opportunities 312. The high leverage capability components 52 may be single capability components 316, or they may be sets or bundles of capability components 316 that are common to a plurality of opportunities 312.

Additionally, in some embodiments, capability components 316 that are deemed ‘advantaged’ have relationships and associated relationship indicators that are weighted more heavily than average towards the use of that component. This may be advantageously applied for a variety of reasons, not limited to the examples as follows. For example, if an asset is owned by the business applying the generative investment process 300, or if the business applying the process 300 has, for example, a privileged knowledge of a relationship or other capability component type 314, then the business may optimize use of the capability component 316 by ensuring that the the generative investment process 300 adapts for the use, benefits and risks of the favored capability component 316. Likewise, capability components 316 that are deemed ‘disadvantaged’ have relationships and associated relationship indicators that are weighted less heavily than average towards the use of that component 316.

In some embodiments, capability components 316 and opportunities 312 may have multiple relationship types and associated relationship indicators between any pair of capability components 316, opportunities 312, or between a capability component 316 and an opportunity 312. These relationships or affinities between each pair of elements may reflect the relative advantaged or disadvantaged status of one capability component 316 or opportunity 312 with a second capability component 316 or opportunity 312. As an example, the advantaged or disadvantaged status incorporates the extent to which a capability component 316 is easily procured or can be used without restriction. This may further aid the evaluation of an opportunity 312, and provide guidance on how readily that opportunity 312 may be executed versus another opportunity.

The evaluations of opportunities 312 may be based on decision criteria that include expected financial benefits, net of expected costs. These financial metrics may include discounted cash flows, yielding a net present value. Alternatively, option-based valuations may be used. Other traditional financial metrics such as internal rate of return or payback time may be used, although these metrics may include additional adjustments to achieve correct results. The net benefits may be adjusted by the expectations or probabilities of success, to yield an expected net benefit for an opportunity. Or, the net benefits for an opportunity 312 may be paired with a probability of success or expectations associated with the ability to execute the opportunity 312, and the pair of metrics may be evaluated, on an absolute basis or on a relative basis, to other opportunities 312. The valuation pair may be plotted in two dimensions, and visually compared to absolute valuation criteria, or, relatively, against the valuation of other opportunities 312. (“Investment Science,” Luenberger, 1998, provides a survey of the current art with regard to investment modeling.)

In evaluating opportunities 312, non-financial benefits and costs may be used independently. Or, non-financial benefits and costs may be used together with financial benefit and cost metrics, as supplemental evaluation criteria. The net benefit of an opportunity 312 may include collective benefits associated with synergies with other opportunities 312. These synergies may include the existence of common capability components 316 among the opportunities 312.

In general, the expected net benefit at a point in time of an opportunity 312, incorporating financial and non-financial benefits and costs, direct and indirect, as well as uncertainties associated with the opportunity 312, may be considered its level of “fitness” against the evaluation criteria. The fitness may be considered both on an absolute basis, and on a relative basis versus other opportunities under consideration.

Evaluations may be conducted on the set of opportunities 312, incorporating the degree to which the opportunities 312 include high leverage capability components 52, as given in the table 310A. As an example, opportunity F includes one high leverage capability component 52 (cc 1). The valuation, or “fitness,” of opportunity F may be comparatively low, relative to opportunity A, which has three high leverage capability components (cc 1, cc 3, and cc 4), or relative to opportunity C, which has four high leverage capability components (cc 1, cc 5, cc 7, and cc 9). Opportunity F may therefore be a candidate for removal from further consideration, at least for some period time. Likewise, opportunity H, includes no high leverage capability components 52, which may cause its valuation or fitness to be determined to be comparatively low, and therefore be a candidate for removal from further consideration, at least for some period of time.

Thus, in FIG. 12, modified map 310B does not include opportunities F and H. Instead, new opportunities J and K are generated by the generative investment process 300. One or more opportunities (J and K) may be generated based on seeking to maximize the use of high leverage capability components. These newly generated opportunities may also contribute toward a determination of additional high leverage capability components 52. For example, in the combinatorial map 310B (FIG. 12), capability component cc 10 is a high leverage capability component 52, due to the association with opportunity J, whereas the capability component cc 10 was not a high leverage capability component in the combinatorial map 310A (FIG. 11). In some cases, individual capability components 316 that have sufficient independent potential may become independent opportunities 312 (e.g., previously established opportunity I is an example of an opportunity which includes a single capability component) Through application of the combinatorial map 310 by the generative investment process 300, the locus of investment decisions shifts from traditional projects and ventures (opportunities 312), to capability components 316, as appropriate.

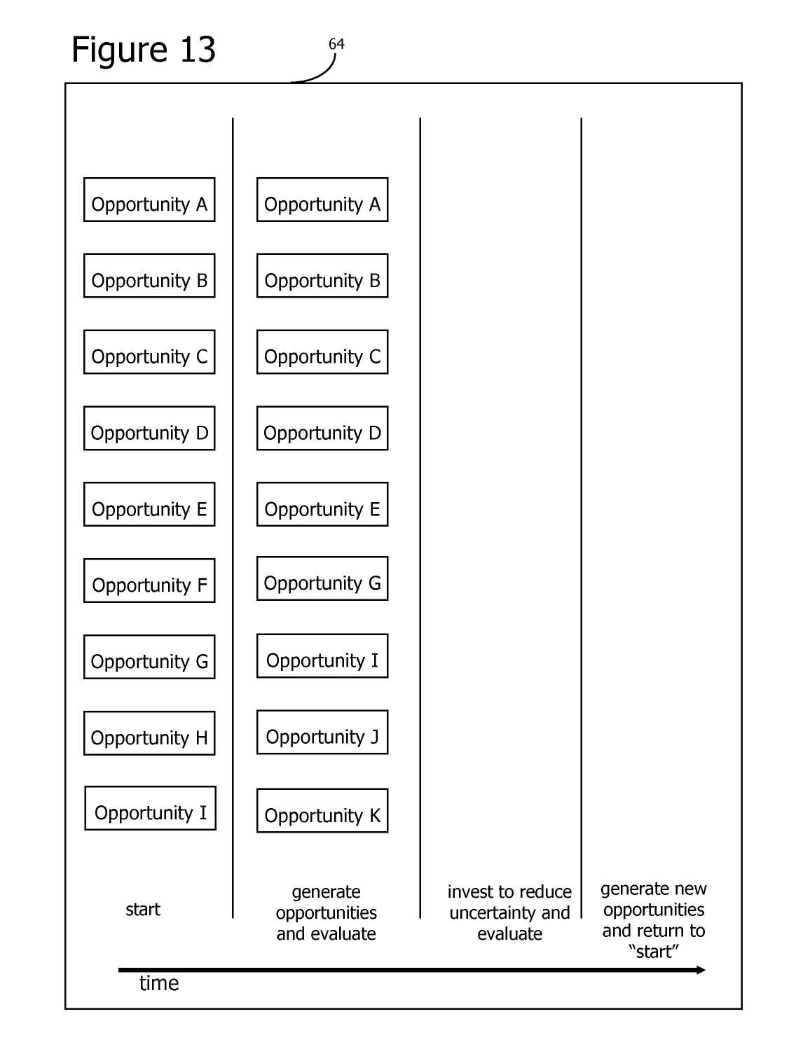

In FIG. 13, a stage gate process 64 reflects the above analysis performed by the generative investment process 300, according to some embodiments. As in the prior art stage gate process 4 (see FIG. 2), the process 64 proceeds over time. The process 64 depicts the decomposition of opportunities 312 into capability components 316, the preliminary evaluation of the opportunities 312, and the generation of additional opportunities 312 based on capability component leverage and synergies, as described in the combinatorial maps 310A and 3106. At the start of the process 64, opportunities A-H, inclusive, are shown. After opportunities F and H are discarded, new opportunities J and K are added in the second stage. Thus, in this example, the number of available opportunities has changed from the original set. In practice, the number of opportunities 312 at a subsequent stage may be greater than, the same as, or fewer than at a previous stage. Thus, the generative investment process 300 is not purely eliminative, as in prior art investment processes.

### Resolving Uncertainties

During the processing of investment criteria, there are often uncertainties associated with capability components 316 and with opportunities 312 as a whole. Thus, it may be worthwhile to understand the value of taking actions to resolve certain uncertainties, at least up to some degree of resolution of the uncertainties.

The expected value of an action can be defined as a function of the expected direct value (non-informational value) of the action, the value of information generated by the action, and the expected cost of taking the action. The value relationship can be written in equation form as follows:

Expected Value of Action X=Expected Direct Value of Action X+Expected Informational Value of Action X−Expected Cost of Action X

Actions whose value is wholly or primarily expected to derive from informational value traditionally are generally referred to by specific, special nomenclature, such as “experiments”, “information gathering”, and “business intelligence.” Examples of specific actions primarily aimed at resolving uncertainty include financial and other business modeling, business and competitor intelligence, customer and market intelligence and feedback, funding source analysis, feasibility studies, intellectual property analysis and evaluations, product (where product may be a service or solution) development testing and experimentation, prototyping and simulations. Product testing may include in vitro and in vivo testing, in silico modeling approaches, including molecular modeling, combinatorial chemistry, classic bench scale testing, high throughput experimentation or screening methods, clinical trials, and field tests. (“Experimentation Matters,” Thomke, 2003, provides a relevant overview of current art regarding experimentation.) Other types of actions may have other, primarily non-informational generated aims, but may be expected to provide relevant information as a by-product. Deciding to defer an action to a definite or indefinite future time may also logically be defined as an explicit action, promoting completeness and consistency in considering action alternatives.

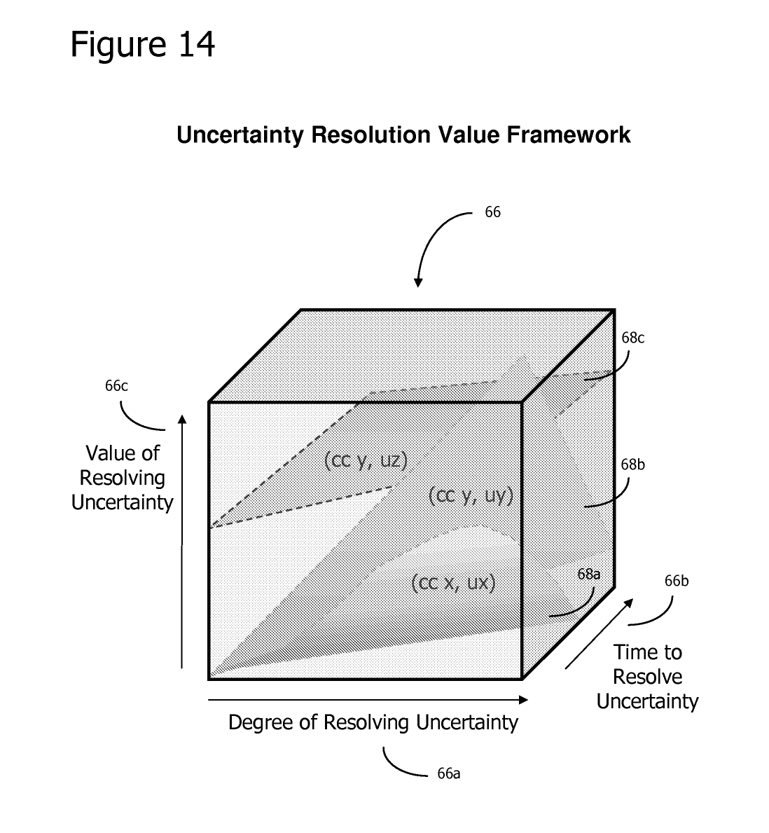

According to some embodiments, FIG. 14 depicts a framework 66 associated with the value of resolving uncertainties that may be used by uncertainty mappings function 341 of the generative investment process 300. The framework 66 has three dimensions. The first dimension 66a is the degree to which an action is expected to resolve uncertainty. This value can range from no expected resolution of the associated uncertainty, to an expectation of complete resolution of the associated uncertainty. The second dimension 66b is the expected time to the availability and interpretation of the information generated by the action. The third dimension 66c is the value of the information associated with the action, given specific values associated with the other two dimensions.

Mappings 68a, 68b, and 68c within the framework 66 are examples of the value maps for all possible actions with respect to a given capability component 316 or set of capability components 316 (or to an opportunity 312 as whole, which may be wholly or partly defined as its associated set of capability components 316), and an uncertainty associated with the capability component 316 or set of capability components 316. Thus, each mapping may be described as a function, (cc n, um), for integers n and m.

For example, mapping 68a represents the information value of all actions associated with capability components cc x, for uncertainties ux while mapping 68b represents the information value of all actions associated with capability components cc y for uncertainties uy. Mappings 68b and 68c represent the information value for all actions for the same capability component, cc y, but with different associated uncertainties, uy and uz, respectively.

The value of information (perfect or imperfect) mapping may be derived from decision tree modeling techniques. Alternatively, the value of information may be calculated from other mathematical modeling techniques, including Bayesian approaches, or Monte Carlo simulations. The value of information may also be affected by other variables associated with the decision makers, such as risk profiles and other utility functions. (The Stanford University manuscript, “The Foundations of Decision Analysis,” Ronald A. Howard, 1998, provides a relevant review of value of information calculation methods.)

Decisions to defer actions for a certain amount of time may be considered explicit actions. The time dimension 66b in the framework 66 takes into account the timing aspect of the value of information function. Further, the degree of resolving uncertainty dimension 66a may not necessarily have a value of zero when deferring an action—additional relevant information may be expected to reveal itself even when no active action is conducted. In other words, this is the value of waiting associated with a specific action.

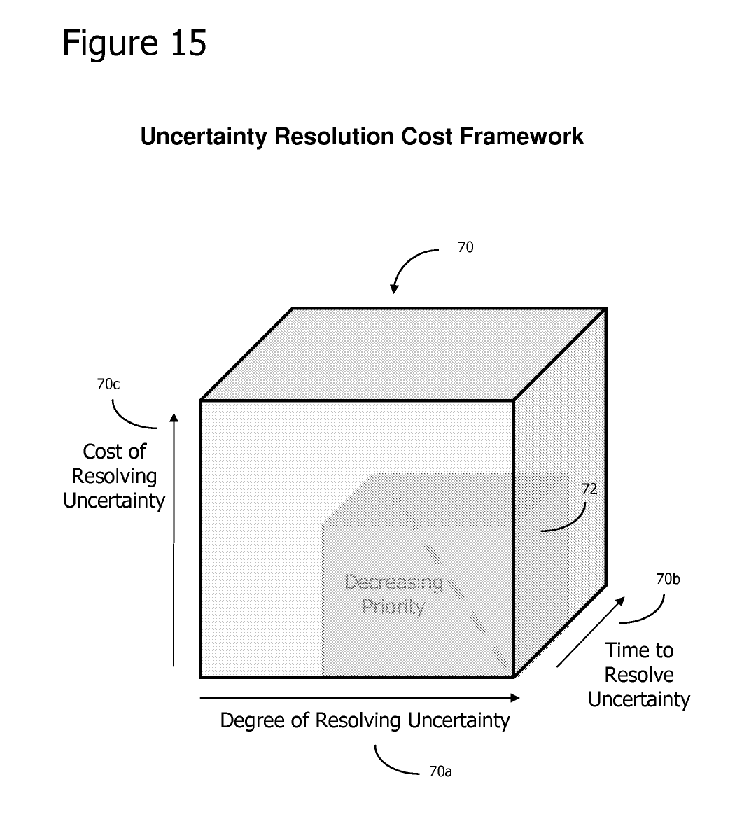

FIG. 15 depicts a framework 70 for evaluating the cost of actions to resolve uncertainty that may be used by the uncertainty mappings function 341 of the generative investment process 300, in some embodiments. The framework 70 has three dimensions. The first dimension 70a is the degree to which the action is expected to resolve uncertainty. The second dimension 70b is the expected cost of taking the associated action to resolve the uncertainty. The third dimension 70c is the expected time it will take to perform the action and interpret the results of the action to resolve the uncertainty. Ignoring the absolute or relative value of the resulting information, it may be desirable to take actions, to the extent they exist, that are expected to be low-cost, timely, and able to significantly resolve uncertainties. The general prioritization of actions on this basis alone is illustrated by the mapping 72.

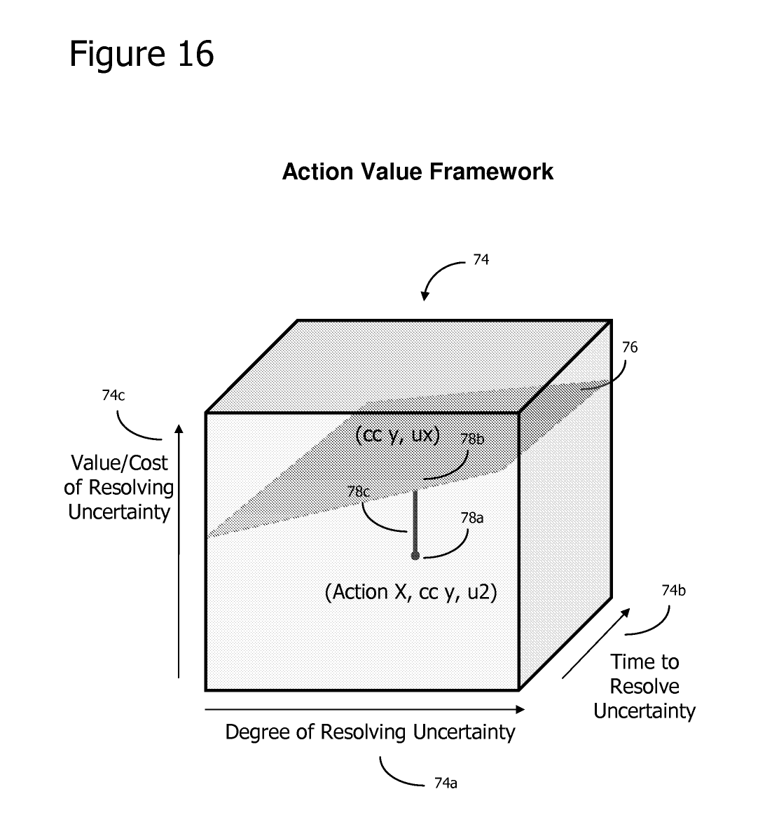

FIG. 16 depicts a framework 74 for evaluating the value of actions versus the cost of actions to resolve uncertainty that may be used by the uncertainty mappings function 341 and the value of information function 342 of the generative investment process 300, in some embodiments. The framework 74 has three dimensions. The first dimension 74a is the degree to which the action is expected to resolve uncertainty. The second dimension 74b is the expected value and cost of taking the associated action to resolve the uncertainty. The third dimension 74c is the expected time it will take to perform the action and interpret the results of the action to resolve the uncertainty. A value map 76 of all possible actions associated with a set of actions relating to a particular capability component cc y, and an associated uncertainty, ux, is shown. One particular action selected from the set of all possible of these actions has a value as shown by 78b. The associated cost of the action is shown as 78a. The net value of the action is therefore the difference 78c.

The net value of all possible actions associated with the opportunities 312 and constituent capability components 316 may be calculated, such that those actions with a positive net value are executed. If two or more actions both have positive net value but are mutually exclusive, then the one with the greater net value may be selected for execution, as one possibility.

Alternatively, a budget limit may be imposed. In these cases, the net value of all possible actions may be ranked, and a cumulative cost may be generated by the value of information function 342, starting with the highest positive net value action and ending with the lowest positive net value action. All actions may be executed that are associated with cumulative cost less than or equal to the budget constraint.

Design of experiment approaches may also be employed by the design of experiment function 344, to help make the most effective choices on actions. These approaches may include, but are not limited to, using factorial experimental designs, or other design of experimental decision techniques such as D-optimal designs.

Optionally, actions may be taken to establish advantageous or privileged positions with regard to capability components 316. Informational advantages may be gained versus other marketplace participants, including, if applicable, the associated capability component 316, to enable the advantageous or privileged position to be attained at an attractive cost. For example, an exclusive relationship with a company may be developed, leveraging informational advantages of the user of the generative investment process 300 that is not available or apparent to others in the marketplace. When the value of the relationship becomes apparent to others, the exclusivity may have already been attained by the user of the process 300, creating an effective barrier to other marketplace participants. In such a case, the action of executing an exclusive relationship might transform an existing capability component 316, for example, a potential relationship, to a new capability component 316, a realized, exclusive relationship. This capability component 316 would then be substituted for the original capability component 316 in associated opportunities 312, and be available for the purposes of potentially generating new opportunities 312.

In FIG. 17, combinatorial map 310C is depicted, as derived from the combinatorial map 310B (FIG. 12). This time, capability components cc 1, cc 9, cc 10, and cc 18 are highlighted. FIG. 17 illustrates example results of actions that generate information, and thereby resolve, to some degree, uncertainty related to capabilities components 316. In the table 310C, information is gained associated with four capability components 316, cc 1, cc 9, cc 10, and cc 18. In this example, it is assumed that information received associated with capability components cc 1 and cc 10 is generally favorable, while information received associated with capability components cc 9 and cc 18 is generally unfavorable. The actions, and the resulting resolution of uncertainties associated with specific actions, may affect the expected value of the capability components 316, as well as all the opportunities 312 including or dependent on the associated capability components 316.

So, for example, everything else being equal, opportunities that include capability components for which generally favorable information has been obtained (cc 1 and cc 10) will increase in value, while opportunities that include capability components for which generally unfavorable information has been obtained (cc 9 and cc 18) will decrease in value. Since opportunity E contains capability component cc 9, opportunity E decreases in value after the resolution of uncertainties. For opportunities that contain one or more capability components for which associated information is assessed as favorable and one or more capability components for which associated information is assessed as unfavorable, the resulting valuation of such opportunities will depend on the magnitude of the offsetting capability component assessments.

Although not necessarily the case in general, in this example, an unfavorable assessment of the information associated with the capability component of an opportunity overrides one or more favorable assessments of the information associated with other constituent capabilities. Therefore, since opportunity C contains capability component cc 9, opportunity K includes cc 9, and opportunity G contains capability component cc 18, opportunities C, K, and G are assessed as decreasing in value after the resolution of uncertainties.

### Generation of New Opportunities

In FIG. 18, combinatorial map 310D is derived from the combinatorial map 310C of FIG. 17. One of the capability components 316 is transformed from the original capability component (cc 10) to a new capability component (cc 30). A motivation for such a change in capability components 316 may include transforming a potential relationship into a realized, exclusive relationship, as one example. Also, as a result of reevaluating capability components 316 and associated opportunities 312, opportunities based on the resolution of uncertainties described above and the resulting decrease in assessed value, opportunities C, E, G, and K, or those opportunities which are identified as having capability components for which associated information is deemed unfavorable, are identified for suspension from the process.

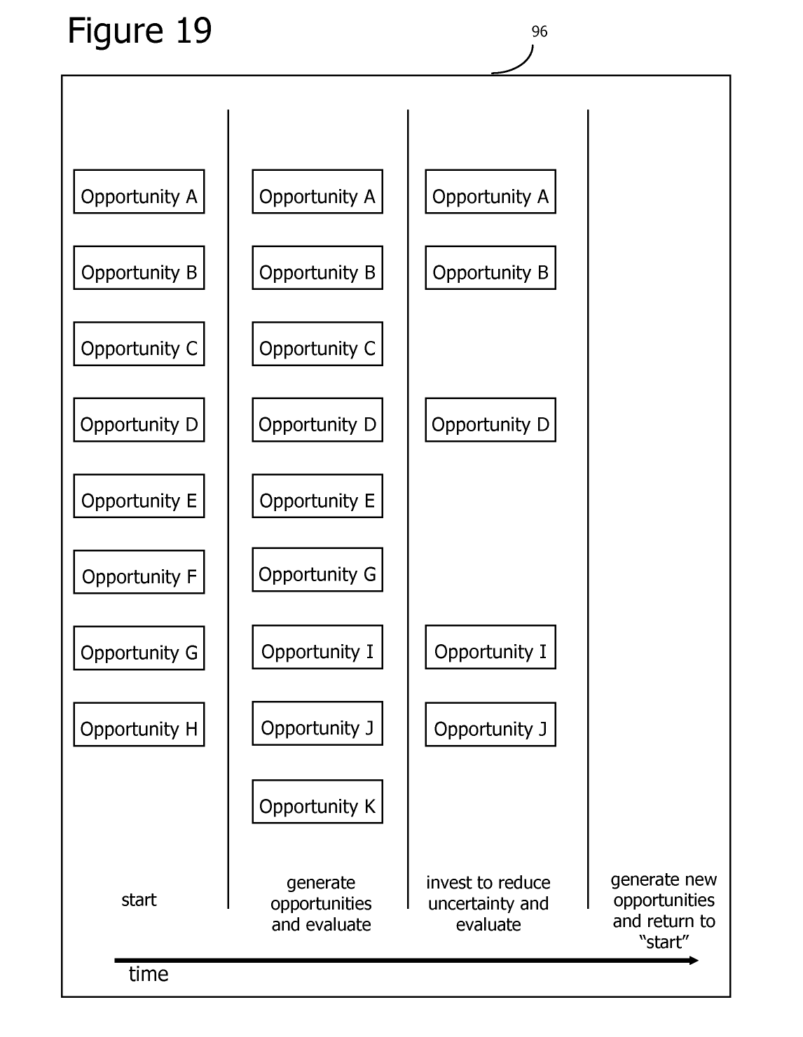

In FIG. 19, a stage gate process 96 reflects the analysis of FIGS. 17 and 18 performed by the generative investment process 300, according to some embodiments. As in the prior art staged process 4 (see FIG. 2) and the process 64 (FIG. 13), the process 96 proceeds over time. FIG. 19 illustrates the results of the evaluation decisions of FIG. 18, based on the information received on capability components 316, as illustrated in FIG. 17. At the third stage of the process 96, opportunities C, E, G, and K have been eliminated. In practice, the opportunities 312 within the process 96 at this stage may be less than, greater than, or equal to, the number of original opportunities of the process.

Returning to FIG. 1, the generative investment process 300 includes discrete combinatorial operators 330, including recombinant operators 332 and innovation operators 334. Using these discrete combinatorial operators, a generative approach to the creation of additional opportunities 312 based on combinations of capability components 316 may be applied by the generative investment process 300. This recombinant approach may be based on one or more applications of one or more “innovation operators.”

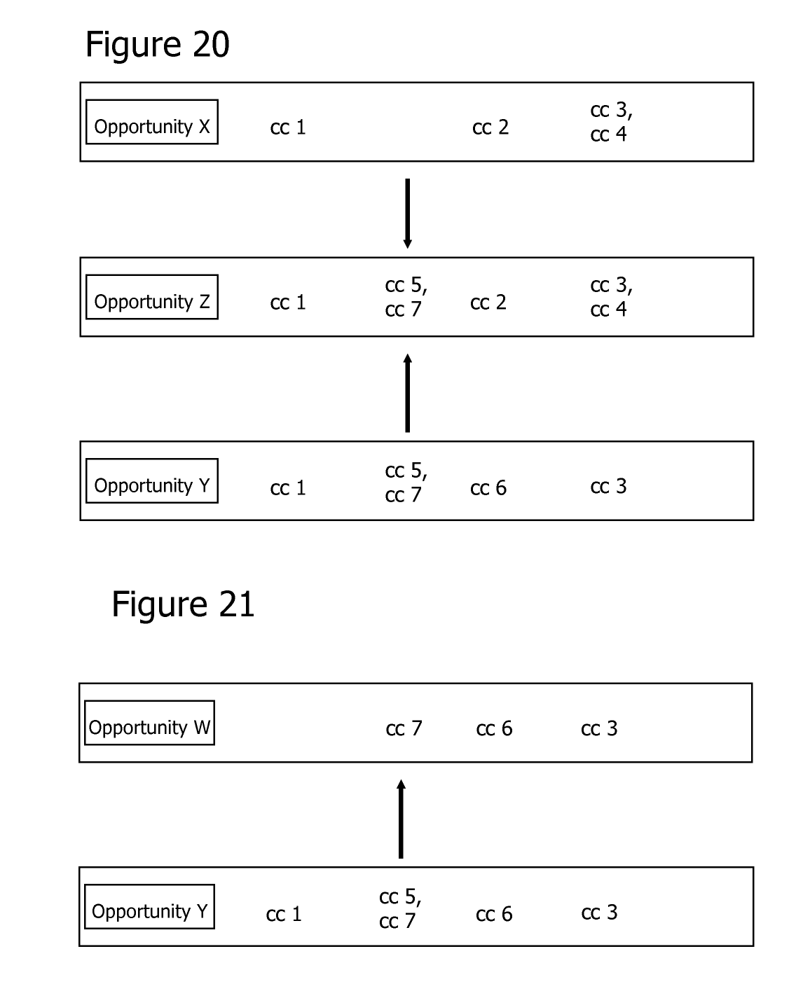

For example, FIG. 20 illustrates a “fusion” operator, for creating new opportunities 312 from other opportunities in the generative investment process 300. The fusion operator is a binary operator that combines a subset of capability components 316 from one opportunity 312 with a subset of capability components 316 of another opportunity 312. (The subset may contain the entire set of the capability components 316 of the opportunity 312.) One or more capability components 316 associated with opportunity X and one or more capability components 316 associated with opportunity Y are combined to create a third opportunity, opportunity Z.

In FIG. 20, capability components cc 2 and cc 4 are taken from opportunity X and combined with capability components cc 5 and cc 7 from opportunity Y to produce opportunity Z. Capability components cc 1 and cc 3 may be thought to have derived from either opportunity X or opportunity Y, as these capability components are present in both source opportunities. While the opportunity Z has all the capability components 316 from opportunity X, one capability component from opportunity Y (cc 6) is not part of the new opportunity. The fusion operator may be implemented through direct human interaction or through application of a computer-based algorithm.

As another example, FIG. 21 illustrates a “fission” operator, for creating new opportunities 312 from other opportunities in the generative investment process 300. The fission operator creates new opportunities 312 through selection of subsets of capability components 316 of other opportunities 312. Three capability components 316 associated with opportunity Y (cc 7, cc 6, and cc 3) are selected to form opportunity W. Capability components cc 1 and cc 5 are not part of the new opportunity W. The fission operator may be implemented through direct human interaction or through application of a computer-based algorithm.

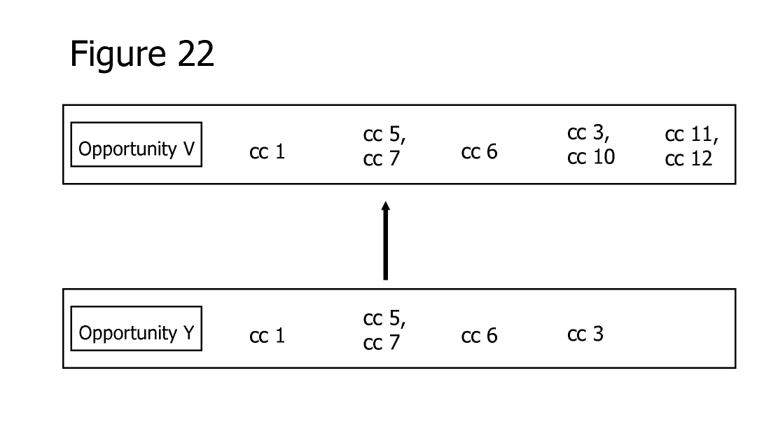

In FIG. 22, an “abstraction” operator may also be used by the generative investment process 300 to create new opportunities 312. The abstraction operator implies generalizing or expanding the scope of the opportunity 312, thereby requiring a superset of capability components 316. One or more capability components 316 associated with opportunity Y (cc 1, cc 5, cc 7, cc 6, and cc 3) are selected. Additional capability components 316 (cc 10, cc 11, and cc 12) are added to the selected capability components from opportunity Y to form a second opportunity, opportunity V. (The additional capability components, cc 10, cc 11, and cc 12, may or may not exist in any other current opportunity under consideration.) As with the fusion and fission operators, the abstraction operator may be implemented through direct human interaction or through application of a computer-based algorithm.

The fusion, fission, and abstraction operators, which are part of the discrete combinatorial operators 330, thus provide a mechanism by which the generative investment process 300 can generate new investment opportunities 312 based on the capability components 316. Further, problem solving techniques, such as those commercialized by Invention Machine, or systematic innovation and technical creativity techniques, such as the Theory of Inventive Problem Solving, or TRIZ (Altshuller, 1999), may be applied to generate new opportunities 312. These techniques may be applied in combination with one or more of the innovation operators above, or independently.

In addition to using the innovation operators, new opportunities 312 may be generated by the generative investment process 300 directly, based on the prior history of success and failure of combinations of capability components 316, their associated types 314, and the use of “advantaged” and/or high leverage capability components, or from marketplace-driven insights, as described below.

### Market and Customer-Driven Opportunities

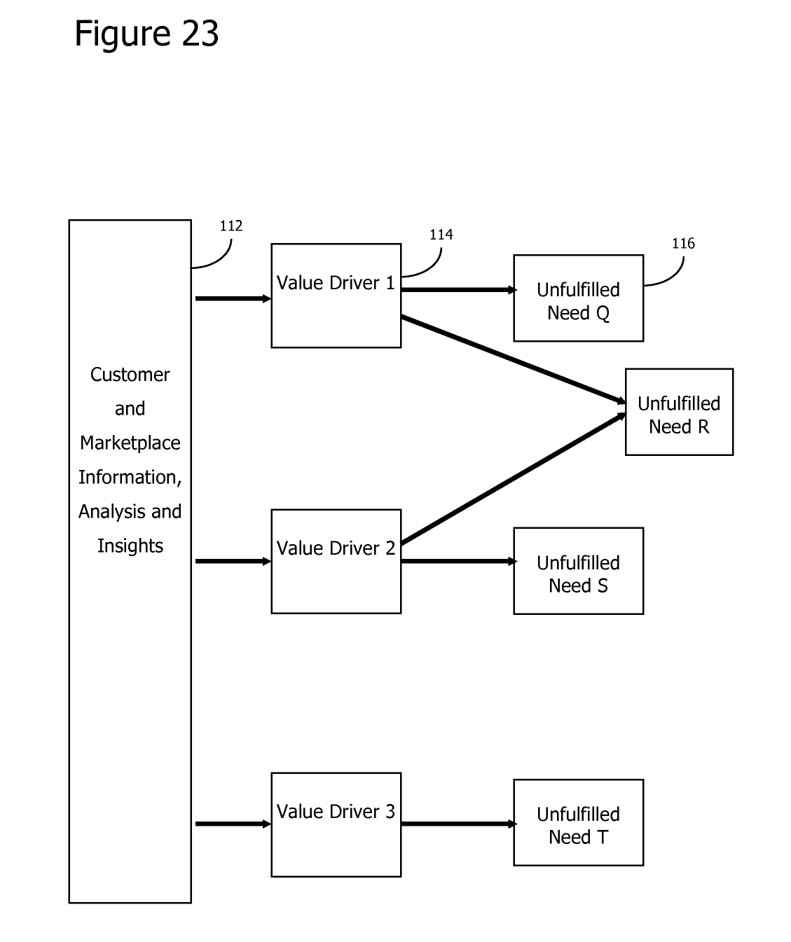

In addition to the above techniques, inferences about marketplace and customer present or future requirements may be used by the generative investment process 300 to generate “idealized solutions” that serve as a basis for generating additional opportunities 312. In FIG. 23, information about customers and the marketplace is gathered, associated analysis is conducted, and insights are derived 112. The information gathering may take the form of customer focus groups, customer and market surveys, evaluation of customer buying habits, evaluation of customer information access habits, general business intelligence, determining the directions and likely requirements of the customers of potential customers, general marketplace trends, general economic trends, and technology trends and futures.

The value drivers 114 of one or more customers are derived based on the analysis and insights 112. Value drivers 114 are those set of activities, assets or processes that can deliver differentiated financial performance relative to the financial performance of a competitor, over time. By definition, improvement in value driver performance has value for a company. Value drivers 114 may be specific to a customer or potential customer, or a single value driver 114 may span multiple customers. In FIG. 23, the customer and marketplace information, analysis, and insights 112 produce three value drivers 114, value driver 1, value driver 2, and value driver 3.

Also depicted in FIG. 23 are unfulfilled needs 116. Unfulfilled (or under-fulfilled) needs may be defined for each of the value drivers 114. Unfulfilled needs 116 are needs that are not currently being met, or are incompletely met, by current suppliers. Or, unfulfilled needs 116 may be anticipated future needs that are expected not to be met or incompletely met by any future supplier, current or potential. In FIG. 23, unfulfilled needs Q and R are associated with value driver 1, unfulfilled needs R and S are associated with value driver 2, and unfulfilled need T is associated with value driver 3. Unfulfilled need R is simultaneously associated with value drivers 1 and 2. Although FIG. 23 depicts unfulfilled needs 116 being derived directly from value drivers 114, and indirectly from customer and marketplace information, analysis, and insights 112, the unfulfilled needs 116 may be directly derived from customer and marketplace information, analysis, and insights 112, in some embodiments.

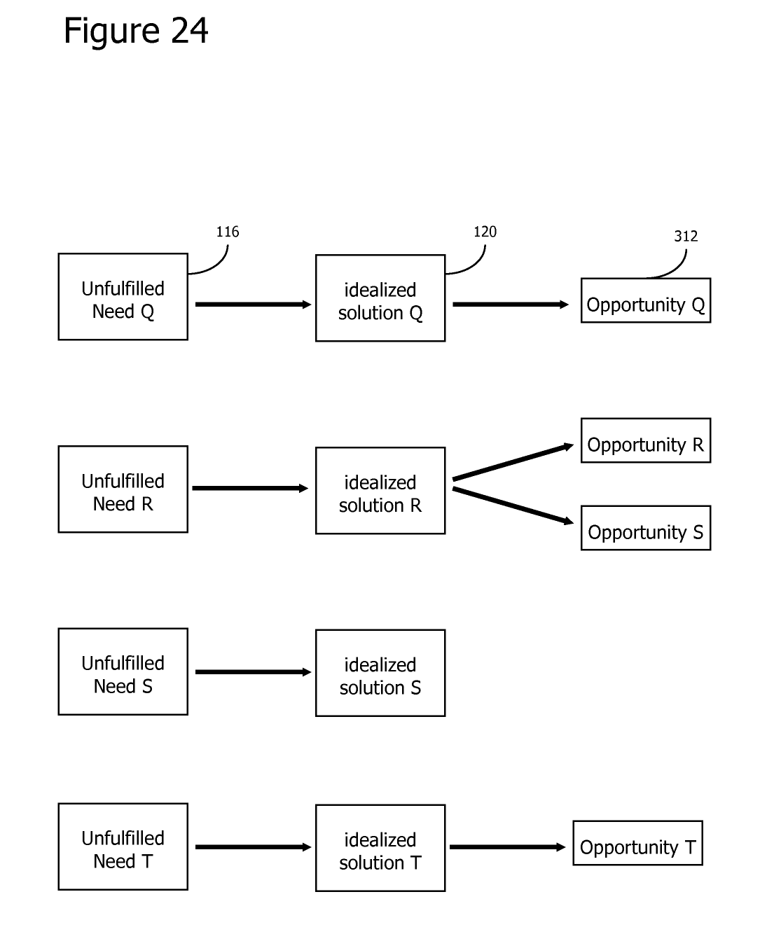

In FIG. 24, the unfulfilled needs 116 from FIG. 23 are used to directly or indirectly generate opportunities 312. One or more idealized solutions 120 may be generated to address each unfulfilled need 116. An idealized solution may be defined as a set of capability components that collectively constitute a solution that could be expected to effectively address some or all of the associated unfulfilled need. Each idealized solution 120 may include one or more capability components 316, which may or may not be capability components already under consideration. None, one, or more opportunities 312 may be generated in association with each of the idealized solutions 120.

Thus, the generation of opportunities 312 through derivation of idealized solutions 120 associated with unfulfilled customer needs 116 may be applied by the generative investment process 300, in addition to the generation of opportunities 312 through the application of innovation operators, such as fusion, fission, and abstraction operators described above.

FIG. 25 depicts combinatorial map 310E, derived from the combinatorial map 310D of FIG. 18, in which new opportunities (Q, R, S, T, and Z) are added to opportunities A, B, D, I, and J. Opportunity Z is generated by an innovation operator, while opportunities Q, R, S, and T are generated through the derivation of idealized solutions 120 to unfulfilled customer needs 116 (FIG. 24). Opportunity Z may have been generated by applying the abstraction operator to opportunity B, which includes capability components cc 1, cc 5, cc 7, cc 6, and cc 3, adding capability components cc 10, cc 11, and cc 12 to form the new opportunity, as one possibility.

As additional opportunities 312 are generated, duplicate opportunities may be removed from the combinatorial map 310E. Since opportunity J, an original opportunity, is identical to opportunity T, a new opportunity, opportunity T may be removed from the set of opportunities under consideration in the map 310E.

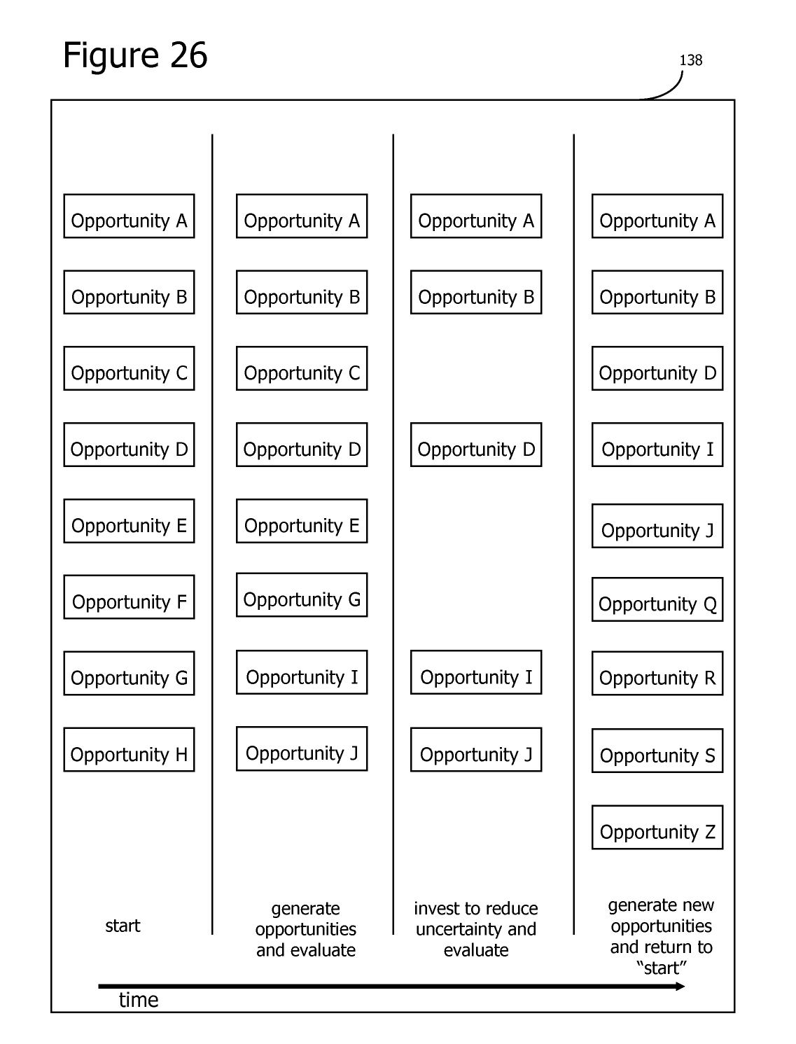

In FIG. 26, a process 138 reflects the above analysis performed by the generative investment process 300. Where opportunities A, B, D, I, and J are present in the third stage, the number of opportunities in the fourth stage actually increased, additionally including opportunities Q, R, S, and Z. Duplicate opportunity T is not present in the fourth stage. The opportunities 312 may exit the process 300 and become part of a separate process, such as a commercialization process, as one example. The remaining set of opportunities 312 may then return to the beginning of the generative investment process cycle.

### Experimental Design and Inferencing

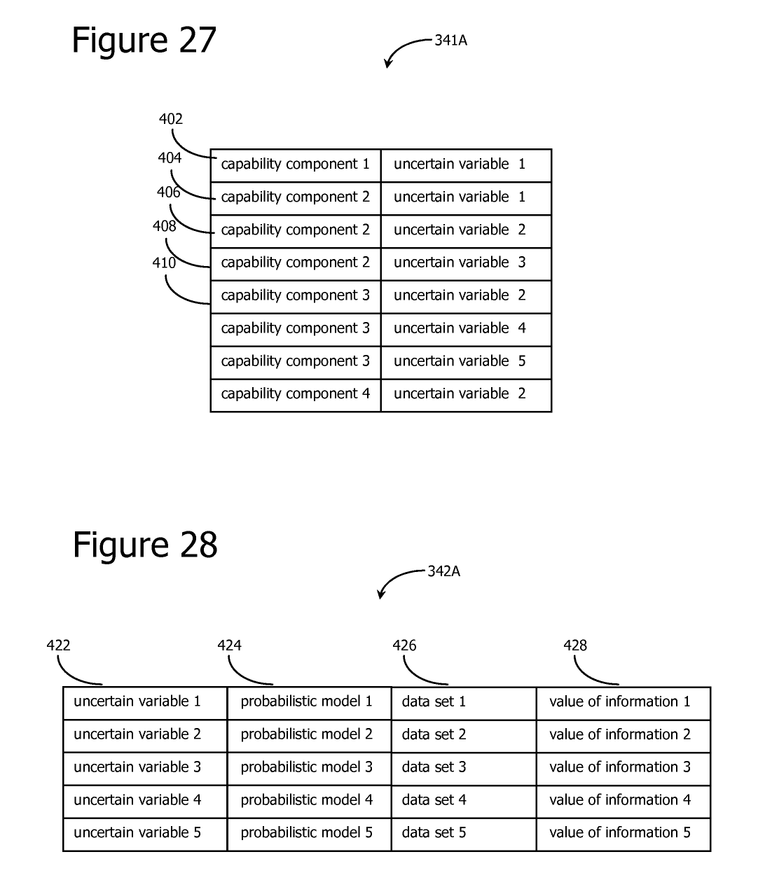

Recall from FIG. 1 that the generative investment process 300 may include an experimental design and inferencing process 340. The experimental design and inferencing process 340 addresses uncertainties that may exist with regard to opportunities 312 and capability components 316 in the combinatorial mapping 310. In FIGS. 27-32, the functions of the experimental design and inferencing process 310 are described in more detail.

In FIG. 27, an uncertainty mapping 341A is depicted, according to some embodiments. The uncertainty mapping 341A represents correspondences between capability components 316 and associated uncertain variables. In the mapping 341A, each row is a pair-wise association between a specific capability component 316 and a specific uncertain variable. For example, in row 402, capability component 1 has a single associated uncertain variable, uncertain variable 1. However, a capability component 316 may have more than one associated uncertain variables. For example, as shown in rows 404, 406, and 408, capability component 2 has three associated uncertain variables, uncertain variable 1, uncertain variable 2, and uncertain variable 3.

An uncertain variable may be not unique to a specific capability component 316. For example, capability component 2 and capability component 3 both have a corresponding uncertain variable 2 (rows 406 and 410). Or, the uncertain variable may be unique to a particular capability component 316. For example, uncertain variable 4 is unique to capability component 3 in the uncertainty mapping 341A.

In FIG. 28, a mapping of probabilistic models, data, and values of information to uncertain variables is depicted, according to some embodiments, described herein for convenience as a value of information function 342A. Recall that the value of information function 342 enables a determination of absolute and relative values of perfect or imperfect information associated with uncertainties of opportunities 312 and capability components 316 within the combinatorial map 310, as defined by the uncertainty mappings 341 (see FIG. 1). The value of information function 342A depicted in FIG. 28 represents correspondences between uncertain variables 422, probabilistic models 424, data or information sets 426, and values of information 428. The probabilistic models 424 associated with uncertain variables 422 may include one or more discrete or continuous probability density functions. Bayesian models may be applied, where appropriate. The data sets 426 associated with uncertain variables 422 represent the body of raw data, processed data or information, and insights or knowledge derived from the data and information. In Bayesian terms, data sets 426 may be interpreted as the prior state of information.

The values of information 428 associated with uncertain variables 422 represent the expected gross value of having varying degrees of additional information incremental to the existing body of information or data sets 426 associated with the uncertain variables 422. The gross value of information is determined from the expected financial or non-financial values associated with capability components 316 (and by extension, the financial or non-financial value of opportunities 312 to which the capability components 316 are associated), combined with levels of certainty associated with the outcomes of the uncertain variable. The values of information 428 may therefore include multiple values, each expected value corresponding to a different set of potential incremental data or information, that each have a corresponding effect on the level of uncertainty associated with the value. The value of information 428 may be represented by a mathematical function that represents the gross value of information as a function of the degree of certainty associated the uncertain variable. One particular value that may be calculated is the (gross) value of perfect information, which is defined as the value of attaining perfect foresight on the outcome of the corresponding uncertain variable. Attaining less than perfect foresight, or imperfect information, may also provide value, but the gross value of imperfect information can be no greater than the bound that it is set by the gross value of perfect information.

The gross value of information 428 for one or more degrees of certainty associated with an uncertain variable 422 may be calculated from the application of decision tree models, or decision lattices. Design of experiment modeling may be applied, including factorial matrices and D-optimal models.

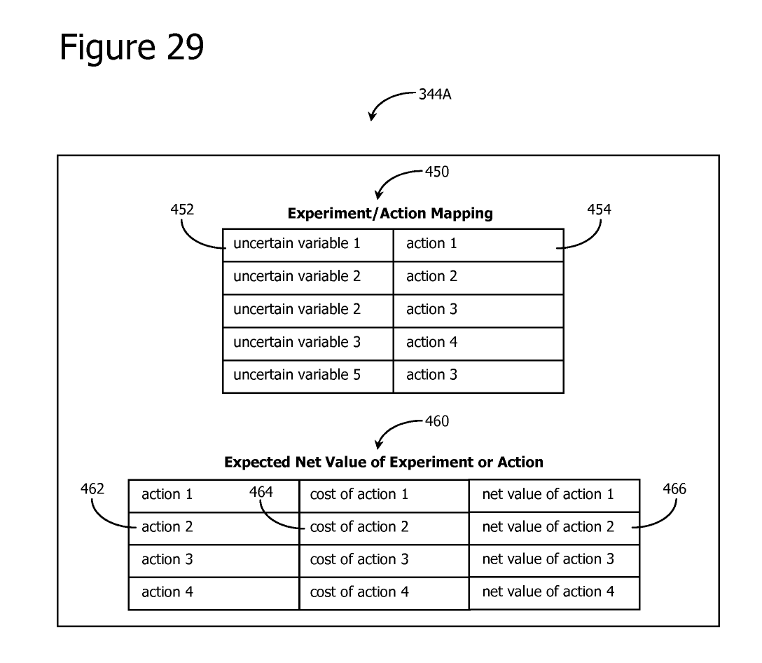

In FIG. 29, a design of experiment function 344A is depicted, according to some embodiments. Recall that, in addition to the value of information 342, the expected cost of conducting experiments or gathering information is incorporated by the design of experiment function 344 in determining an effective information gathering plan. The design of experiment function 344A includes an experiment/action mapping 450 and an expected net value of experiment or action mapping 460. It should be understood that “experiment” represents just one type of the more general term “information gathering action” or just “action.”

The experiment/action mapping 450 represents correspondences between uncertain variables 452 and information gathering actions 454. Each uncertain variable 452 may have one or more actions associated with it. An action 454 may correspond to one or more uncertain variables 452.

The expected net value of experiment or action mapping 460 represents correspondences between actions 462, the costs of the actions 464, and the net values of the actions 466. The net value of the action 466 is calculated by subtracting the cost of the action 464 from the expected gross value of information associated with the action. The expected gross value of information of the action is calculated by mapping the expected information to be attained by the action to the values of information 428 (FIG. 28) associated with the corresponding uncertain variable or variables.

The design of experiment function 344A may include algorithms to assess a collection of actions, wherein the individual actions do not necessarily produce independent results, to determine what subset of the collection of actions to conduct in a first time period. In other words, where the collection of actions may result in associated incremental information of individual actions “overlap,” in the sense of the associated incremental information having some degree of correlation; the design of experiment function 344A assesses groupings of actions rather than just individual actions. In such cases, the design of experiment function 344A will assess the net value of information associated not only with the individual actions within the collection of actions, but also with the net value of information associated with subsets of the collection of actions. The design of experiment function 344A may include processes or algorithms based on design of experiment modeling such as factorial matrices and D-optimal models.

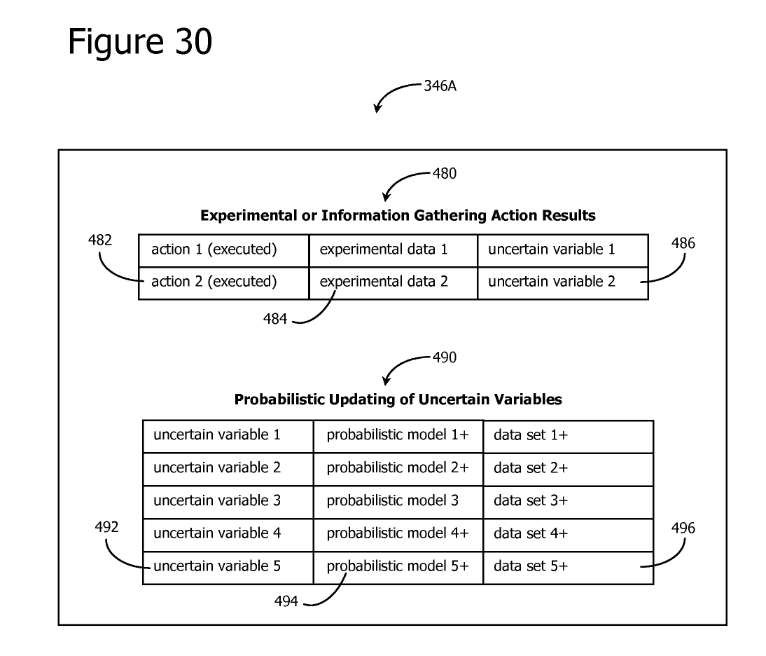

In FIG. 30, a statistical inferencing function 346A is depicted, according to some embodiments. The statistical inferencing function 346A includes an experimental or information gathering action results mapping 480 and a probabilistic updating of uncertain variables mapping 490. The mapping 480 represents a mapping of executed actions 482, experimental data attained by the executed actions 484, and the uncertain variables 486 to which the experimental data attained by executed actions corresponds. A specific instance of the experimental data 484 may map to more than one of the uncertain variables 486. The probabilistic updating of uncertain variables mapping 490 represents the mapping of uncertain variables 492 to updated probabilistic models 494 and updated data sets 496 (the updated probabilistic models 494 and data sets 496 are designated as updated by appending the “+” symbol to the corresponding items in the probabilistic updating of uncertain variables map 490). The updated data sets 496 represent the body of data, information or knowledge associated with an uncertain variable after the experiment or information gathering action has been conducted and the results assimilated.

The updated data sets 496 therefore represent the additional information 484 from the experimental or data gathering actions added to the corresponding previously existing data sets 426. In some cases, the probability densities associated with probabilistic models 494 may be unchanged after the data sets 496 are updated based on the nearly attained information. In other cases, the probability densities associated with the updated probabilistic models 494 may change. The changes may relate to parameters associated with the probability density (for example, the variance parameter associated with a Gaussian density function), or the probability density function itself may change (for example, a Gaussian density function changing to a log normal density function). Statistical processes or algorithms may be used to directly make inferences (the statistical processes or algorithms constitute the probabilistic model 494) or to update probabilistic models from the newly attained information. Statistical modeling techniques that may be applied include linear or non-linear regression models, principal component analysis models, statistical learning models, Bayesian models, neural network models, genetic algorithm-based statistical models, and support vector machine models.

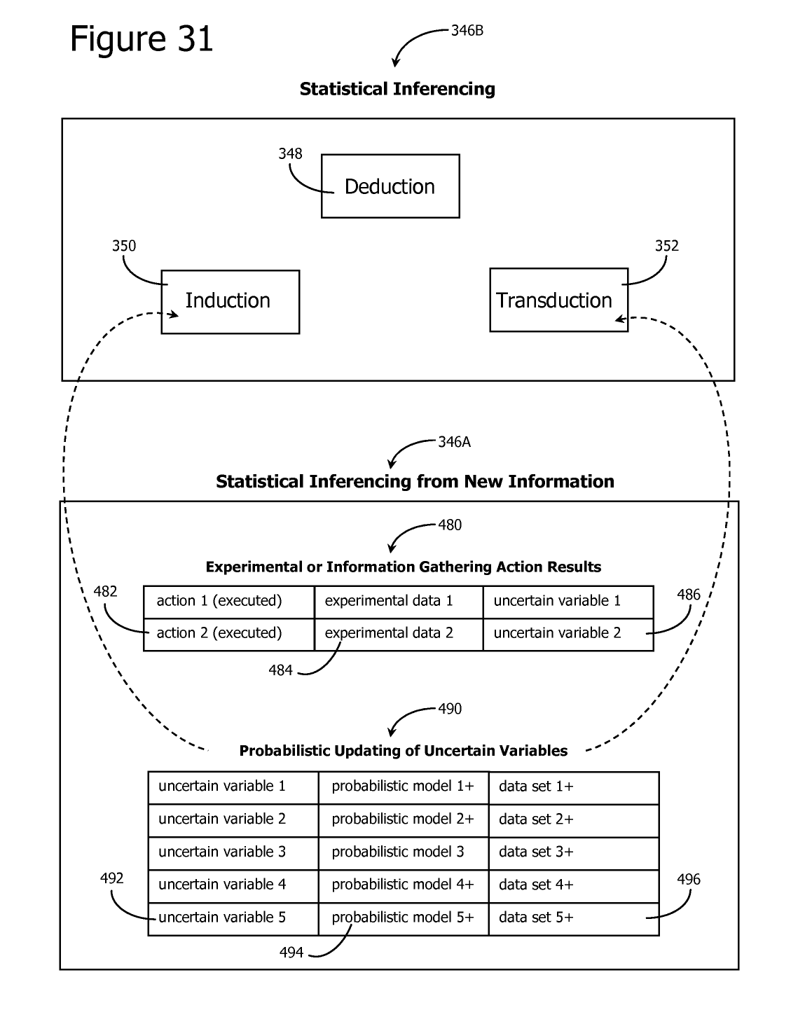

In FIG. 31, a second statistical inferencing function 346B is depicted, for updating the probabilistic models, according to some embodiments. Statistical inferencing function 346B includes the general inferencing functions deduction 348, induction 350, and transduction 352. Induction 350 and transduction 352 are both driven by the assimilation of new data or information, as reflected in the tables 480 and 490 from the statistical inferencing function 346A. Induction 350 is a generalization function that uses specific data or information to derive a function, in this case a probabilistic function or model, to enable a general predictive model. In other words, the induction function 350 preferably seeks to find the best type of probability density function to fit the data available. Once a probabilistic model is in place, the model can be used by the deduction function 348 to predict specific values from the generalized model.

Transduction 352 is a more direct approach to predicting specific values than induction 350 and deduction 348. Applying a transduction approach recognizes that, under some circumstances, there may be no reason to derive a more general solution than is necessary, i.e. deriving an entire density function from data. That is, some level of useful predictive capabilities may be possible without deriving an entire density function for an uncertain variable. This may be particularly the case when the body of existing data 496 is relatively sparse. The transduction function 352 may be based on an empirical risk minimization (ERM) function applied to appropriate data sets, or training sets. Or, alternative functions may form the basis of the transduction. (“The Nature of Statistical Learning Theory,” Vapnik, 2000, provides a review of transduction and statistical learning.)

The deduction function 348 or the transduction function 352 may inform the design of experiment or information gathering process 344 (see FIGS. 1 and 29). Thus, output from the statistical inferencing function 346 may directly or indirectly feedback, automatically or with human assistance, to the design of experiment function 344, thereby enabling an adaptive design of experiment process.

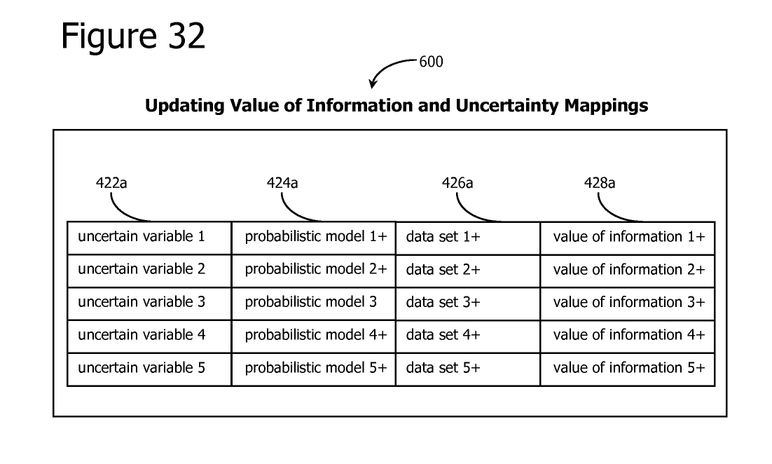

In FIG. 32, yet another approach to executing the experimental design and inferencing function 340 of FIG. 1 is depicted, according to some embodiments. Here, the uncertainty mappings 341 and value of information function 342 are simultaneously represented in a table 600. The updating value of information and uncertainty mappings 600 represent updates to mapping 342A (see FIG. 28) after conducting experiments or information gathering, and assimilating the information within the experimental design and inferencing function 340. Uncertain variables 422a have corresponding updated probabilistic models 424a, updated data sets 426a, and updated values of information 428a. The updated values of information 428a are derived from the value models associated with the opportunity and capability combinatorial map 310, the uncertainty mappings 341, and the updated probabilistic models 424a.

Hence, in some embodiments, a closed loop process is enabled, integrating design of experiment 344, statistical inferencing 346, and value of information 342. This closed loop process may be automated within a computer-based system.

### Implementation Options

Given the many features described above, the generative investment process 300 may replace existing investment and opportunity development processes. Or, the generative investment process 300 may integrate with, or operate in parallel with, legacy investment and opportunity development processes. The generative investment process 300 may also be used as a forecasting model that is continually updated by the use of marketplace inferences, idealized solutions, and value drivers 114, as described earlier. Based on the success/failure history of the portfolio of opportunities 312 within a company, and associated capability components 316 in combination with the marketplace inferences, competitor intelligence, idealized solutions, and knowledge of customer value drivers, the simulation of future states and scenarios is possible.

This predictive model, based on prior experience and other inputs as detailed above, may provide an outline of an opportunity portfolio 318 to aid executive decision making, and to further identify which capability components 316 or associated component characteristics may be of highest leverage in the future. The leverage profile of capability components 316 for a future time may well be quite different from the leverage profile at the present.

The generative investment process 300 may be embodied as an adaptive process, as outlined in U.S. Provisional Patent Application, No. 60/572,565, entitled “A Method and System for Adaptive Processes,” filed on May 20, 2004. In such embodiments, the workflow enabling the generative investment process 300, as described herein, may be embedded within an adaptive process. The adaptive process may utilize a fuzzy network structure, and provide adaptive navigation of the generative investment process 300 workflow and supporting content, as well as access to the combinatorial investment portfolio elements and auxiliary analytical applications. Aspects or subsets of the generative investment process 300 may be syndicated or otherwise distributed to other systems that host instances of the generative investment process.

In some embodiments, the generative investment process 300 is implemented as a business method within an organization. The generative investment process 300 may be implemented, in whole or in part, as a software program executed on a processor-based system. Alternatively, the generative investment process 300 may be implemented in hardware, such as by using discrete logic devices, or the process 300 may be implemented using a combination of hardware and software elements. The processor-based system executing the generative investment process 30 may thus be thought of as a generative investment system.

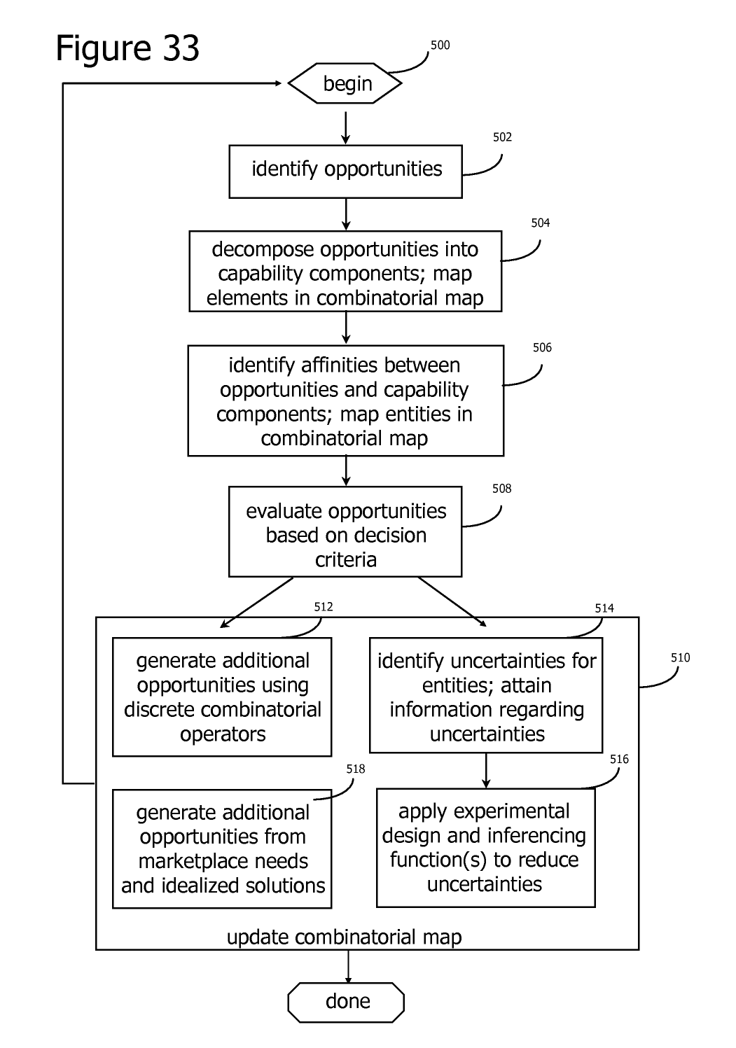

In FIG. 33, a flow diagram depicts the generative investment process 300 of FIG. 1, according to some embodiments. Opportunities 312 to be evaluated are identified (block 502), then decomposed into constituent capability components 316, as described above. The elements (opportunities 312 and capability components 316) are mapped in a combinatorial map, such as the combinatorial map 310 of FIG. 1 (block 504). Recall that affinities describe relationships, relationship types, and their associated relationship values or weightings, between the elements in the combinatorial map. Entities, which include the elements and their affinities, are then reflected in the combinatorial map (block 506). (The affinities may optionally include synergies.)

Once the combinatorial map is populated, the opportunities in the combinatorial map are evaluated based on one or more decision criteria (block 508), as described above. The combinatorial map is then updated (block 510). The updates may occur by using the discrete combinatorial operators (such as fission, fusion, and abstraction) to generate new opportunities based on existing opportunities (block 512), or through application of other systematic innovation procedures or techniques, such as ARIZ/TRIZ.

The originally identified opportunities (block 502) may be derived from customer or marketplace unfulfilled needs 116 and/or associated idealized solutions 120. Further, customer or marketplace unfulfilled needs 116 and/or associated idealized solutions 120 may be utilized to generate new opportunities (block 518) for the purpose of augmenting or updating the combinatorial map.

Or, the updates to the combinatorial map may be derived from identifying uncertainties for entities within the combinatorial map. The uncertainties may relate to the opportunities, the constituent capability components, or the affinities between elements. Information is then attained regarding the uncertainties (block 514). One or more experimental design and inferencing functions are applied to the attained information, preferably to resolve, and thereby reduce, the uncertainties (block 516). Once the combinatorial map is updated, a new evaluation process may begin (see feedback loop). The process steps described in FIG. 33 are merely illustrative, and may occur in a different order than is presented. Further, some of the steps are optional.

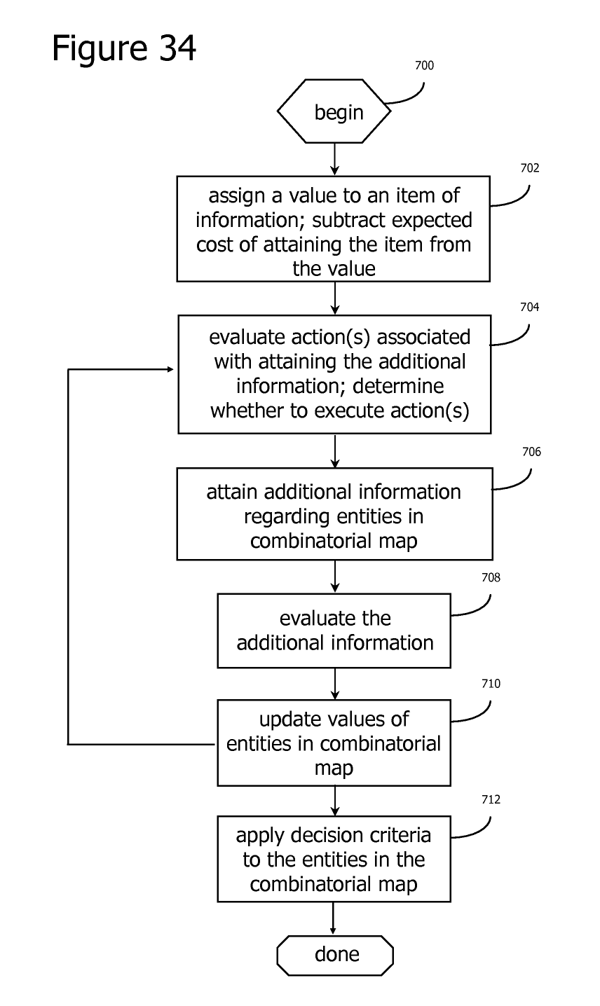

In FIG. 34, the experimental design and inferencing process 340 of the generative investment process 300 of FIG. 1 is depicted, according to some embodiments. Recall that the experimental design and inferencing process involves the mapping of uncertainties (uncertainty mappings 341), as well as the value of information function 342, the design of experiment function 344, and the statistical inferencing function 346. In FIG. 34, the experimental design and inferencing process 340 is shown to be applied to resolve uncertainties during the investment process.

The process 700 begins by assigning a value to an item of information that could be applied to provide a degree of resolution of one or more uncertainties corresponding to one or more entities of the combinatorial map 310. The expected cost of attaining the additional information may be subtracted from this value (block 702). The expected cost may include a factor associated with the expected time of attainment. Assigning a value to the item of information may include applying a modeling method to determine the value of the item. Examples of modeling methods are given, above. Alternatively or additionally, one or more actions associated with attaining the additional information may be evaluated. Based on this evaluation, a decision whether to execute the one or more actions is made (block 704).

Once the additional information is attained (block 706), the additional information is evaluated (block 708). The evaluation may include applying a statistical model to the attained information or integrating the statistical model with a design of experiment model. Once the additional information is evaluated, the uncertainty maps and the values of entities in the combinatorial map is updated (block 710). A feedback may be enabled such that updates to the uncertainty maps and the values of entities in the combinatorial map are used to automatically or semi-automatically generate or evaluate one or more actions associated with attaining the additional information (block 704). This feedback may be implemented through integration of statistical inferencing processes and capabilities with design of experiment processes and capabilities.

Finally, decision criteria are applied to the entities in the combinatorial map (block 712). The process steps described in FIG. 34 are merely illustrative, and may occur in a different order than is presented. Further, some of the steps are optional.

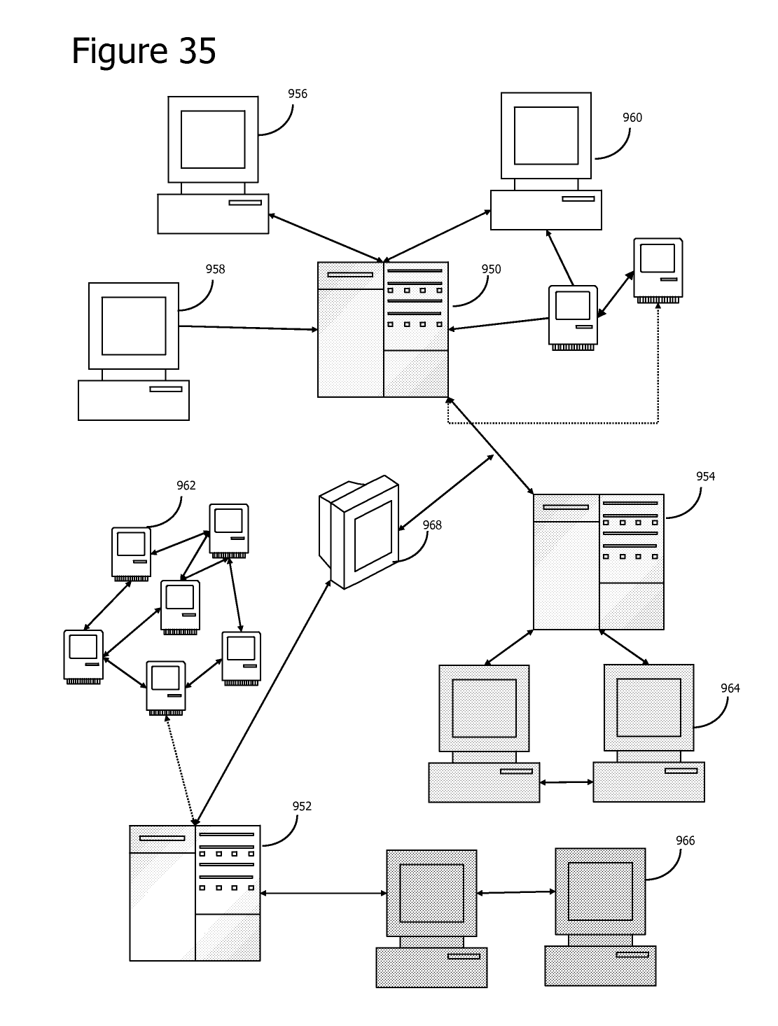

FIG. 35 depicts various hardware topologies that the system of the generative investment process 300 may embody. Servers 950, 952, and 954 are shown, perhaps residing a different physical locations, and potentially belonging to different organizations or individuals. A standard PC workstation 956 is connected to the server in a contemporary fashion. In this instance, the generative investment process 300, or functional subsets thereof, such as the combinatorial map 310, may reside on the server 950, but may be accessed by the workstation 956. A terminal or display-only device 958 and a workstation setup 960 are also shown. The PC workstation 956 may be connected to a portable processing device (not shown), such as a mobile telephony device, which may be a mobile phone or a personal digital assistant (PDA). The mobile telephony device or PDA may, in turn, be connected to another wireless device such as a telephone or a GPS receiver.

FIG. 35 also features a network of wireless or other portable devices 962. The generative investment process 300 may reside, in part or as a whole, on one or more of the devices 962, periodically or continuously communicating with the central server 952. A workstation 964 connected in a peer-to-peer fashion with other computers is also shown. In this computing topology, the generative investment process 300, as a whole or in part, may reside on each of the peer computers 964.

Computing system 966 represents a PC or other computing system which connects through a gateway or other host in order to access the server 952 on which the generative investment process 300 resides. An appliance 968, includes software “hardwired” into a physical device, or may utilize software running on another system that does not itself host the system upon which the generative investment process 300 is loaded. The appliance 968 is able to access a computing system that hosts an instance of the generative investment process 300, such as the server 952, and is able to interact with the instance of the generative investment process 300.

While the present invention has been described with respect to a limited number of embodiments, those skilled in the art will appreciate numerous modifications and variations therefrom. It is intended that the appended claims cover all such modifications and variations as fall within the scope of this present invention.

What is claimed is:

1. A method, comprising:
decomposing a plurality of investment opportunities into capability components;
establishing a fuzzy network of objects executed on a processor-based computing device comprising a combinatorial map, wherein elements of the combinatorial map comprise the plurality of opportunities and the capability components;
reducing an uncertainty associated with an element of the combinatorial map through execution of an information gathering action; and
modifying the fuzzy network of objects in accordance with the reduced uncertainty.

2. The method of claim 1, further comprising:
applying a combinatorial operation to the combinatorial map; and
generating a new opportunity.

3. The method of claim 1, further comprising:
determining at least one affinity between a first capability component and a second capability component.

4. The method of claim 1, further comprising:
accessing a probability distribution representing the uncertainty.

5. The method of claim 1, further comprising:
generating an expected value of the information gathering action.

6. The method of claim 1, further comprising:
applying an experimental design process to elements of the combinatorial map.

7. The method of claim 1, further comprising:
evaluating a plurality of the opportunities based on decision criteria.

8. The method of claim 1, further comprising:
identifying a plurality of investment opportunities, wherein the investment opportunities are selected from a group consisting of solutions to an unfulfilled marketplace need, commercial venture opportunities, corporate venture opportunities, research opportunities, development opportunities, innovation projects, business development opportunities, business growth opportunities, capital allocation opportunities, business operational opportunities, and private individual investment opportunities.

9. The method of claim 1, further comprising:
decomposing a plurality of investment opportunities into associated capability components, wherein the capability components are selected from a group consisting of products, technologies, services, skills, relationships, brands, mindshare, methods, processes, financial capital, financial assets, intellectual capital, intellectual property, physical assets, compositions of matter, life forms, physical locations, and people.

10. A method, comprising:
accessing an uncertainty associated with an entity of a fuzzy network of objects executed on a processor-based device comprising a combinatorial map, the combinatorial map comprising entities, the entities comprising opportunities, capability components, and affinities;
planning an action to attain information about the uncertainty;
attaining information about the uncertainty; and
modifying the fuzzy network in accordance with the reduced uncertainty.

11. The method of claim 10, further comprising:
accessing the uncertainty, wherein the uncertainty is represented by a probability distribution.

12. The method of claim 10, further comprising:
determining the expected value of attaining the information about the uncertainty.

13. The method of claim 10, further comprising:
planning a plurality of actions to attain information about the uncertainty; and
generating a sequence of the plurality of the actions.

14. The method of claim 10, further comprising:
applying a statistical inferencing model to the attained information.

15. A system, comprising:
a fuzzy network of objects executed on a processor-based computing device comprising a combinatorial map, the entities of the combinatorial map comprising opportunities, capability components, and affinities therebetween, wherein the opportunities comprise capability components;
an uncertainty associated with an entity of the combinatorial map;
a computer-implemented function that accesses the result of an information gathering act that reduces the uncertainty; and
a computer-implemented function that modifies the combinatorial map in accordance with the result of the information gathering action.

16. The system of claim 15, further comprising:
a probability distribution associated with the uncertainty.

17. The system of claim 15, further comprising:
an experimental design function.

18. The system of claim 15, further comprising:
a function that makes a statistical inference from the result of the information gathering act.

19. The system of claim 15, further comprising:
a function that evaluates an entity of the combinatorial map based on decision criteria.

20. The system of claim 15, further comprising:
a function that generates a new opportunity by applying a combinatorial operation to the combinatorial map.
